(19) United States
(12) Patent Application Publication
(10) Pub. No.: US 2022/0261798 A1
(43) Pub. Date: Aug. 18, 2022

(54) Computer-Implemented System and Method for Facilitating Transactions Associated with a Blockchain Using a Network Identifier for Participating Entities

(71) Applicant: nChain Holdings Limited, St. Johns (AG)

(72) Inventors: Craig Steven WRIGHT, London (GB); Jack Owen DAVIES, London (GB); Jad Faisal WAHAB, London (GB)

(21) Appl. No.: 17/626,107

(22) PCT Filed: Jul. 3, 2020
(86) PCT No.: PCT/IB2020/056293

§ 371 Date: Jan. 10, 2022

(30) Foreign Application Priority Data
Jul. 11, 2019 (GB) 1909960.5

(51) Int. Cl. G06Q 20/38; G06Q 20/06; H04L 9/00; H04L 9/32; H04L 9/08

(52) U.S. Cl. CPC G06Q 20/38215; G06Q 20/065; H04L 9/50; H04L 9/321; H04L 2209/56; H04L 9/3239; H04L 9/0825; H04L 9/083; G06Q 2220/10; H04L 9/3263

(57) ABSTRACT

The present disclosure proposes methods and devices for facilitating IP transaction involving digital assets over the Internet directly based on IP addresses for entities. The aspects and embodiments of the present disclosure enable secure IP address transactions by ensuring that the public key of the recipient is never used in the generation of payment destination addresses, thereby making message replay and MITM attacks extremely hard to implement by an attacker. Furthermore, the aspects and embodiments ensure that the payment destination addresses for digital assets are based on new or single use private as well as public keys that are computed or provided based on the public key for the recipient and are specific to a given transaction.

### CROSS REFERENCE TO RELATED APPLICATIONS

This application is a U.S. National Stage of PCT Application No. PCT/IB2020/056293 filed on Jul. 3, 2020, which claims the benefit of United Kingdom Application No. 1909960.5, filed on Jul. 11, 2019, the entire contents of which are incorporated herein by reference.

### TECHNICAL FIELD

This disclosure relates generally to methods, devices and systems for performing or facilitating transactions relating to digital assets over a communication network. The disclosure is particularly suited, but not limited to a technique for facilitating digital asset transactions pertaining to a distributed ledger to an IP address of an entity via the Internet.

### BACKGROUND

In this document we use the term ‘blockchain’ to include all forms of electronic, computer-based, distributed ledgers. These include consensus-based blockchain and transaction-chain technologies, permissioned and un-permissioned ledgers, shared ledgers, public and private blockchains, and variations thereof. The most widely known application of blockchain technology is the Bitcoin ledger, although other blockchain implementations have been proposed and developed. While Bitcoin may be referred to herein for the purpose of convenience and illustration, it should be noted that the disclosure is not limited to use with the Bitcoin blockchain, and alternative blockchain implementations and protocols associated with ant kind of digital asset or a representation of a digital asset fall within the scope of the present disclosure. The term “user”, “sender”, “recipient” may refer herein to a computing or processor-based resource. The term “Bitcoin” is used herein to include any version or variation that derives from or is based on the Bitcoin protocol. The term “digital asset” may refer to any transferrable asset such as cryptocurrency, tokens representing at least a part of a property, a smart contract, a license, i.e. software license, or DRM contracts for media content etc. It will be understood that the term digital asset is used throughout this document to represent a commodity that may be associated with value that may be transferred to or provides as a payment in a transaction from one entity to another.

A blockchain is a peer-to-peer, electronic ledger which is implemented as a computer-based decentralised, distributed system made up of blocks which in turn are made up of transactions. Each transaction is a data structure that encodes the transfer of control of a digital asset between participants in the blockchain system and includes at least one input and at least one output. Each block contains a hash of the previous block to that blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. Software clients installed on the nodes perform this validation work on an unspent transaction (UTXO) by executing its locking and unlocking scripts. If execution of the locking and unlocking scripts evaluate to TRUE, the transaction is valid, and the transaction is then written to the blockchain. Thus, in order for a transaction to be written to the blockchain, it must be i) validated by the first node that receives the transaction—if the transaction is validated, the node relays it to the other nodes in the network; and ii) added to a new block built by a miner; and iii) mined, i.e. added to the public ledger of past transactions.

Once stored in the blockchain as a UTXO, a user can transfer control of the associated resource to another address associated with an input in another transaction. This transfer is usually done using a digital wallet. This digital wallet may be a device, physical medium, program, application (app) on a computing device such as a desktop, laptop or a mobile terminal, or a remotely hosted service associated with a domain on a network work, such as the Internet. The digital wallet stores public and private keys and can be used to track ownership of resources, tokens and assets etc. associated with a user, receive or spend digital assets, transfer tokens which may relate to digital assets such as cryptocurrencies, or licenses, or property or other types of resource.

Many forms of messaging, i.e. communications or data exchanges, that take place over the Internet, which is a public and open wireless network, uses an Internet Protocol (IP) address, which is a unique public address assigned to a computing resource (also referred to herein as a node or an entity) by an Internet Service Provider (ISP). For an IP communication, which includes transfer of some data, a sender contacts a recipient's IP address, perhaps to initially find out if the IP address supports a type of intended communication. If so, a server or host associated with the recipient will send or generate a public key and send it to the sender, so that the sender may send the communication or data to or based on this public key. However, IP addresses are not presently used for transfers or messages involving digital assets. Such transfers or messages are hereinafter referred to as IP transactions. This is because, while in theory using IP addresses to send/receive digital payments or assets may function, they are not so adopted, as communications to IP addresses are vulnerable to man-in-the-middle (MITM) attacks. In such an attack a malicious MITM could intercept a message or communication and have the digital asset sent to themselves instead of the intended recipient during the above process, thereby fraudulently posing as the intended recipient while providing the sender with their own public key instead.

Currently, in order to facilitate a digital asset transaction, for example a token or a Bitcoin BSV or Ethereum etc. payment between two users, i.e. from Alice and Bob, over an open and public network such as the Internet, a digital wallet ecosystem is employed. Alice would need to have a digital wallet associated with her (private and public) cryptographic keys and would need to know or be provided with Bob's digital wallet address. Wallet addresses as are usually automatically generated by an address generation program and are a string of digits in a specific format that is recognised by the network used for transactions. For instance, these may be referred to as Bitcoin addresses for BSV based cryptocurrency networks and are usually the public key or hash of the public key of an asymmetric private/key pair associated with an entity. Wallet addresses are then shared between users of a network, so that other users know where to send payments of digital assets to. Alice would thus need to know or be provided with this type of an address to send cryptocurrency to Bob. Furthermore, more than one type of address may be used by a wallet for different types of transactions, and these addresses may only be used once to facilitate one transaction written on the blockchain. Thus, using digital wallets for establishing a digital payment destination address for a digital asset payment, where each wallet may have one or more public address that are specific to a wallet, is presently considered a reliable and secure and is therefore an accepted norm for digital asset transactions.

Given that an entity or an endpoint (a computing resource) when communicating over the Internet is already issued with a unique IP address, aspects and embodiments of the present disclosure propose techniques for improving the security, robustness and reliability of transactions involving digital assets between these entities where a payment destination is or is based on an IP address. This is to enable a digital asset to be securely sent directly to an IP address of a recipient, thereby facilitating a secure and direct IP transaction from a sender to a recipient. This technique is proposed as an alternative to, or in some cases to be used in combination with a digital wallet-based ecosystem that is currently adopted by digital asset transactions to generate a payment address, such as a Bitcoin address.

### SUMMARY

The present disclosure proposed methods and devices for facilitating IP transaction involving digital assets over the Internet directly based on IP addresses for entities. In some aspects, IP transactions for payments utilising the IPv4 standard are considered, that may be based on DNSSEC and TLS certificate frameworks to generate secure payment addresses from IPv4 addresses. For transactions using IPv6 addresses cryptographically-generated addresses that can have the dual-purposes of securing an IPv6 address and receiving digital asset payments are also considered.

The aspects and embodiments of the present disclosure enable secure IP address transactions by ensuring that the public key of the recipient is never used in the generation of payment destination addresses, thereby making message replay and MITM attacks extremely hard to implement by an attacker. Furthermore, the aspects and embodiments ensure that the payment destination addresses for digital assets are based on new or single use private as well as public keys that are computed or provided based on the public key for the recipient and are specific to a given transaction.

Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

Aspects and embodiments of the present disclosure will now be described, by way of example only, and with reference to the accompany drawings, in which:

FIG. 1 is a flow diagram depicting a method of implementing a transaction according to a first aspect of the present disclosure, the method implemented by one or more processors of a sender entity.

FIGS. 2a and 2b depict existing mechanisms for generating a cryptographically generated address (CGA) for a computing resource communicatively coupled with other computing resources over the Internet.

FIG. 3 depicts an existing mechanism for generating an advanced cryptographically generated address (CGA++) for a computing resource communicatively coupled with other computing resources over the Internet.

FIG. 4 is a flow diagram depicting a method of implementing a transaction according to a second aspect of the present disclosure, the method implemented by one or more processors of a sender entity.

FIG. 5 is a flow diagram depicting a method of implementing a transaction according to the first and/or second aspects of the present disclosure, the method implemented by one or more processors of a recipient entity.

FIG. 6a is a flow diagram depicting a method of improving the security of transactions according to a third aspect of the present disclosure, the method implemented by one or more processors of a sender entity.

FIG. 6b is a flow diagram depicting a method of improving the security of transactions according to the third aspect of the present disclosure, the method implemented by one or more processors of a recipient entity FIG. 7a is a flow diagram depicting a method of implementing a transaction according to a fourth aspect of the present disclosure, the method implemented by one or more processors of a sender entity.

FIG. 7b is a flow diagram depicting a method of implementing a transaction according to the aspect of the present disclosure, the method implemented by one or more processors of a recipient entity.

FIG. 8 is a flow diagram depicting a method of implementing a transaction according to a fifth aspect of the present disclosure, the method implemented by one or more processors of a sender entity.

FIG. 9 is a schematic diagram illustrates a computing environment in which various aspects and embodiments of the present disclosure can be implemented.

### DETAILED DESCRIPTION

In accordance with a first aspect of the present disclosure, a computer implemented method for implementing at least one transaction associated with a distributed ledger is provided. In some embodiments, the distributed ledger is a blockchain. The at least one transaction is being from sender and is meant for a recipient, whereby the sender and recipient are each associated with a respective payment entity among a plurality of payment entities that are communicatively coupled via a communication network, and whereby each payment entity among the plurality of payment entities is a computing resource associated with a network identifier that is specific to said payment entity.

The method of the first aspect, when implemented by one or more processors associated by the sender, comprises obtaining a public key P1 for the recipient, then verifying that the obtained public key P1 is associated with the network identifier of the recipient. Responsive to the verification being successful, the method further comprises calculating a further public key P2 pertaining to a given transaction, where the further public key P2 is based on the obtained public key P1, and where the given transaction is associated with a digital asset. The method then comprises computing a payment destination address for the recipient based on the further public key P2, generating an output script for the given transaction based on the payment destination, and then providing an unspent transaction output (UTXO) based on the output script to the distributed ledger.

Accordingly, the method according to the first aspect proposes authenticating the public key P1 of the recipient by verifying that it is indeed associated with the network identifier, and furthermore proposes that another key, i.e. the further public key P2, is computed based on the authenticated public key P1. In turn, it is the newly computed further public key P2 that is then used for computing the payment destination address for a transaction. Advantageously, this improves the security of transactions for network addresses, the transactions associated with digital assets by rendering them resilient to man in the middle (MITM) attacks or message replay attacks by a malign party. In such attacks a malicious MITM could intercept the message and have the digital asset sent to themselves instead, and fraudulently pose as the intended recipient while providing the sender with their own destination address or key. A message replay attack is similar to this, where a malign party intercepts and attempts to relay the same message one or more times to confuse a destination or recipient that the message is being sent from a genuine sender rather than a malign party, thereby prompting a response to the message, which may go to or provide undesired access to the malign entity, rather than the genuine payment entity, i.e. the sender, that originally sent the message.

By authenticating the public key P1 to establish that it is indeed the key for the recipient, and then using a different key P2 based on the authenticated key P1 to calculate a payment destination address for the transaction, attacks relating to interception and impersonation of the recipient becomes much harder to implement. This is particularly advantageous for transactions over the Internet are facilitated by the fourth version of the Internet Protocol (IP) standardised network protocol, i.e. IPv4, where only 32-bits are allocated for the IP addresses. This limits the possible IPv4 addresses assigned to nodes to approximately 4.3 billion unique addresses. Most Internet traffic is based on IPv4 protocol. Communications using IPv4 thus have some security protocols available for use, such as Domain Name System Security Extension (DNSSEC), which is based on using Certificate Authorities (CAs) and a Public Key Infrastructure (PKI), and/or Transport Layer Security (TLS) protocols, which may not be sufficient for messages concerning digital assets. Thus, the first aspect advantageously increases the security of IPv4 transactions, thereby enabling secure IP transactions involving digital assets.

A further advantage of the first aspect is that no extra functionality needs to be implemented by either a sender or a recipient that is already operating using the IPv4 standard for Internet communications for sending and/or receiving digital assets. Thus, the sender does not need to interact with, or wait for a response from the recipient in order to send the recipient a digital asset payment, i.e. transfer a digital asset to the recipient, in a secure manner. Thus, the first aspect enables an asynchronous or discontinuous or non-interactive technique for facilitating IP transactions of digital assets over the Internet, that does not require the recipient to be online at the same time as the render, and that does not require a response or interaction from the recipient in order to process the digital asset payment.

The one or more entities or payment entities referred to above are computing resources or user terminals such as mobile devices or laptops etc, or applications associated with a processor. In some embodiments the network identifier may be, or may include a domain name of a network, for example www.nchain.com. In some embodiments, the domain name is known to the sender, or may be obtained from a network address of the recipient that is known to the sender. In some embodiments, the network identifier may include the location or end point or network address of a responsible host, server, or one or more processors for the recipient. In some embodiments, the network identifier may be an endpoint identifier or universal resource identifier (URI). In some embodiment the public key(s) for an entity, such as the recipient in the first aspect is a stable elliptic curve digital signature algorithm (ECDSA) public key. An ECDSA public key will be a valid point on the secp256k1 curve, compressed, and hex-encoded.

In some embodiments, the output script includes a reference to the network identifier of the recipient. Advantageously, this enables the output scripts, or the UTXOs for, or relating to, a given recipient to be readily and/or easily identified by one or more servers or computing resources associated with the recipient that either monitor or query a distributed ledger for transactions relating to digital assets for the recipient.

In some embodiments, the obtained public key P1 is part of a cryptographic key pair that includes a private key V1. In some embodiments, one or more records or files or data associated with network identifier are encrypted with the private key V1. Advantageously, this enables encryption and/or decryption of data using one of the keys of the cryptographic key pair, while the opposite action is facilitated by the other. In some embodiments, where the network identifier is a domain name, the cryptographic key pairs may relate to a zone keys, such as those used for DNSSEC, where the public key P1 may be a zone signing key ZSK for securing all records related to a domain name, and the private key V1 may be a key signing key KSK to secure the ZSK.

In some embodiments, the obtained public key P1 (cryptographic key or public identifier or template) is digitally signed by a trusted authority, such as a certification authority (CA) to associate the obtained public key P1 to the network identifier of the recipient, and wherein the step of verifying the obtained public key P1 is performed based on another public key P3 associated with the trusted authority. Advantageously, using a trusted third-party authority such as a CA to validate the recipient associated with the public key further increases the security of transactions from the sender to the recipient. Thus, the first aspect of the present disclosure is operable with existing IPv4 security extensions or protocols such as DNSSEC.

Although P1 is referred to as a public key for the recipient, it will be understood that some embodiments of the present application are not limited to this being a public cryptographic key for the recipient. For instance, P1 may be a transaction template that may be is generated and/or stored for the recipient, either periodically or randomly transactions for the recipient. This template may specify how a recipient chooses to receive a digital asset payment to the network address associated with the recipient entity. For example, The recipient may generate a custom locking script that is made available, similar to a public key P1 being made public. Advantageously, using a public template is particularly useful for complex scripts, i.e. key puzzles for example. Thus, when the sender obtains the public template associated with the recipient, one or more inputs or messages in relation to a digital asset can be provided to complete the template. The completed template may then be sent back to the recipient, perhaps in some embodiments, signed by a cryptographic key associated with the sender. Therefore, while the description herein and henceforth refers to a public key P1 for the first and all other aspects, it is to be understood that the disclosure is not so limited to using a cryptographic key (for encryption/decryption) for the purpose of calculating a payment destination address for the recipient. The scope of the disclosure may also include embodiments where a public template for a transaction for the recipient is used, and this may include a custom or locking script that is directly associated with the network address for the recipient, rather public cryptographic key for that network address.

In some embodiments, a recipient may also have a public cryptographic key for use in applications or communication other than a digital asset transaction and may use a public template for embodiments and applications concerning digital assent transactions for the recipient. Thus, the term public key P1 herein may in some instances be understood to cover both, a cryptographic public key or a transaction template. Hereinafter, although P1 is referred to, and described as public key P1 for all aspects and embodiments, for ease of reference—this is not limited to a cryptographic key.

In some embodiments, where the network identifier is a network address such as an IP address (for example an IPv4 address) associated with the recipient, rather than a domain name, the public key P1 may be obtained based on key exchange information associated with the network address. In some embodiments, the step of verifying the obtained public key P1 is performed based on a certificate issued by a trusted authority (CA) for the network address. Advantageously, as with the previously discussed embodiment, the first aspect is operable with existing IPv4 security protocols such as TLS.

In some embodiments, the method includes accessing a database relating to a plurality of network identifiers. For example, this database may be a directory. This directory may be an open, i.e. accessible and/or a decentralised system such as the Domain name system (DNS), and may be referred to as a global directory. The method may further include identifying a record associated with the network identifier of the recipient. In some embodiments, the record may be a text or a service record in the directory, where a security indicator or flag is used to confirm whether or not the network identifier is using a security protocol such as DNSSEC, TLS, or any similar protocol that may be used for authenticating the recipient. It will be understood that while the embodiments herein discuss the use of security extensions and protocols such as TLS and DNSSEC, other techniques relating to secure key management and exchange protocols or variations of PKI are also envisaged.

The first aspect relates to an asynchronous technique, where no interaction is required for a transaction to be processed, as mention above. Accordingly, in embodiments related to the first aspect where a public transaction template is used rather than a cryptographic key, such public template may be made available, obtained by, or known to the sender based on an entry in a directory such as the DNS that pertains to the network identifier for the recipient. For instance, there may be a text record or a service record (SRV) with details of the public template to be used for obtaining a payment destination for the recipient, instead of a public cryptographic key, which can be accessed by the sender thereby facilitating an asynchronous communication flow for the digital asset transaction.

In accordance with a second aspect, the present disclosure provides a computer implemented method for implementing at least one transaction associated with a distributed ledger. When implemented by one or more processors associated with a sender, the method comprises the steps of determining a network address for the recipient, said network address being associated with a public key P1 for the recipient. In the second aspect, rather than a network identifier such as a domain name of a responsible host, the network or IP address of the recipient, or the responsible host or server for the recipient, is determined or obtained. In some embodiments, the network address in the second aspect is a cryptographically generated address (CGA), which may be derived from a cryptographic key pair including the public key P1 associated with the recipient, and a corresponding private key V1.

The method of the second aspect as implemented by the sender then includes verifying that the network address is generated for and is specific to the recipient. Responsive to the verification being successful, the method of the second aspect, similar to the first aspect, then comprises calculating a further public key P2 pertaining to a given transaction based on the public key P1 or the recipient, the given transaction associated with a digital asset. The method includes computing a payment destination address for the recipient based on the further public P2 key, generating an output script for the given transaction based on the payment destination; and providing an unspent transaction output (UTXO) based on the output script to the distributed ledger.

The second aspect of the present application, when implemented by a sender, has all the same advantages as those described above in relation to the first aspect, i.e. facilitating secure IP transactions for transfer of digital assets thereby mitigating MITM or message replay attacks, given a further public key P2 based on the public key or public template of the network address of the recipient is what is used for computing a payment destination address for the recipient, as well as enabling a non-interactive or asynchronous implementation on behalf of the sender and the recipient. Additionally, since embodiments of the second aspect are based on a network or IP address such as a CGA, such aspect and related embodiments are particularly advantageous for transactions over the Internet are facilitated by the sixth version of the Internet Protocol (IP) standardised network protocol, i.e. IPv6, where 128-bits are allocated for the IP addresses (rather than the 32-bit IPv4 address based transactions as discussed above for the first aspect). IPv6 was introduced, with larger 128-bit addresses to overcome some limitations of the 32-bit IPv4 protocol address. However, as the wider Internet usage is largely predicated upon the IPv4 standard, widespread upgrading to the usage of IPv6 has not yet taken place, even though IPv6 offers much more options for enabling secure IP transactions, such as the use of Cryptographically Generated Addresses (CGAs). A CGA is a self-certifying address that doubles up as a method for binding public keys to an IPv6 address of a computing resource or node, without the need for network addresses to be verified based on a trusted CA using PKI (which is needed in IPv4). Thus, advantageously the second aspect requires no extra functionality needs to be implemented by either a sender or a recipient associated with a CGA and already operating using the IPv6 standard, in order to facilitate for sending and/or receiving digital assets based on the network address.

As with the first aspect, in some embodiments relating to the second aspect a public transaction template associated with the recipient may also be used for a generating a payment destination address. In such embodiments, such public template may be made available, obtained by, or known to the sender based on an entry in a directory such as the DNS that pertains to the network identifier for the recipient, thereby facilitating an asynchronous communication flow for the digital asset transaction.

As with the embodiments relating to a first aspect, the output script in some embodiments of the second aspect include a reference to a network identifier of the recipient, so that when provided on the distributed ledger, transaction(s) with digital assets meant for the recipient can be easily identified, which is advantageous.

In some embodiments, the step of verifying the network address is based on a digital signature provided by a trusted authority (CA) for establishing a secure communication channel with the recipient. This is useful in situations where the network address is not a CGA and related to a different type of IP address generated for the recipient. This advantageously also enables PKI based security protocols to also be used in the second aspect, if the address of the recipient is not a CGA, in order to validate that the public key P1 is indeed bound to the recipient.

In some embodiments, when the network address of the recipient is indeed a CGA, the step of verifying the network address is performed based on a digital signature of a private key V1 that is included in a hash function used to generate the CGA for the recipient. Thus, advantageously the second aspect enables authenticating the CGA based on the cryptographic private key V1 (which is related to public key P1) used to generate the CGA, thereby in turn binding the public key P1 of the CGA to the recipient.

As discussed above, the first and second aspects as implemented by the sender to enable IP transactions using an IP address or a network identifier associated with an IP address for a recipient in a non-interactive or asynchronous manner, so that the sender may send the digital asset payment without interacting directly with the recipient. Some embodiments that are common to both or apply equally to the first and second aspects when implemented by the sender are discussed below.

In some embodiments, calculating the further public key P2 for the recipient includes the step of the applying a secure hash function to a data item M associated with the given transaction to obtain a result, where the data item M relates to the digital asset to be provided to the recipient. The method then associates the public key P1 for the recipient with the result. In some embodiments the secure hash of the data item M is multiplied by a common generator G or a common secret that may be selected, randomly generated, or assigned in order to enable secure communication between two nodes for blockchain based technologies and personal device security. Such a technique has been discussed in GB2561728 published on 24^{th} October 2018. Thus, in the first and second aspects of the present disclosure for embodiments using a common Elliptic Curve Cryptography (ECC) system based on secp256K1, the step of determining the further public key P2 may be based on elliptic curve point addition of the obtained public key P1 to the elliptic curve point multiplication of deterministic key and a common generator G. In such embodiments, the deterministic key is the secure hash of the data item M, which may be a message or indicator that relates to the digital asset being transferred.

Advantageously, calculating a new public key P2 for each transaction based on a data item that is related to the digital asset for a given transaction ensures that the obtained or known public key P1 of the recipient is never directly used for sending a digital asset payment or transaction to the recipient. In other words, once a UTXO is written into the distributed ledger, the public key is not the key that is used for spending the transaction, or for calculating a key for spending a transaction. This makes the IP transactions, whether IPv4 or IPv6 is used, more secure. Furthermore, if a common secret, such as a generator G is used, then security against impersonation attacks is further increased for all IP transactions from the sender to the recipient, as it will be very hard for a malign party to be able to intercept the transaction based on the newly generated public key P2 that is based on the obtained public key P1 for the recipient.

In some embodiments, the step of computing the payment destination address for the recipient includes computing a pay to public key hash P2PKH value based on applying a double hash function of the further public key P2. Advantageously, since the payment destination address is now based on the newly calculated public key, that is a one-time key based on the data item M and is harder to obtain by a malign party, the IP transaction to the recipient is rendered more secure.

In some embodiments, the step of providing the UTXO to the distributed ledger in the first and second aspects when implemented by the sender includes providing an additional non-spendable output having a locking script including the network identifier or the network address, i.e. IP address, of the recipient for the given transaction. In some embodiments, the non-spendable output further includes the data item M that that relates to the digital asset. In some embodiments, the non-spendable output includes a link or transaction identifier to identify the executable or spendable UTXO for the transaction.

Advantageously, including a non-spendable output with the network identifier or address of the recipient, for example an OP_RETURN script that is used to signify a valid transaction, this will enable the operable or spendable UTXO including the digital asset to be readily and easily identified when in the distributed ledger by one or more processors associated with the recipient. A further advantage is that provision of a non-spendable output that identifies the recipient, either by the network identifier enables an asynchronous or non-interactive approach, as the sender does not need to interact with the receiver for or to signal a digital asset payment. The recipient can simply query the blockchain or the distributed ledger to identify the non-spendable OP_RETURN transaction(s) that are meant for it. Once UTXOs for the recipient are identified, they can then be processed by executing the spendable output scripts to process the digital asset payment.

In some embodiments, related to the first and second aspects when implemented by the sender, the method further includes the steps of calculating a session key K, wherein the session key is based on the further public key P2 for the given transaction, a private key V2 associated with the further public key and the public key P1 associated with the recipient. Once calculated, the session key K is then used to encrypt the data item M of the given transaction, the data item M relating to the digital asset. The output script is then generated based on the encrypted data item M. In some embodiments, the data item M may be the digital asset to be transferred or many be a message including or an identifier to the digital asset to be transferred to the recipient.

Advantageously, this embodiment increases the security of an IP transaction from a sender to a recipient by increasing the privacy of the data that is being provided on the distributed ledger in one or more UTXOs that are for the recipient. When provided on the blockchain, any unrelated observer monitoring the distributed ledger may be able to view a UTXO. For instance, the non-spendable output like the OP-RETURN can be viewed by any party to obtain details of the transaction or UTXO with the digital asset for the recipient, almost in a similar manner that a recipient does. Therefore, the present embodiment proposes encrypting at least a portion of the UTXO for the transaction that relate to the digital asset, i.e. data item M, thereby increasing privacy and rendering the portion unreadable to an observer of the distributed ledger other than the intended recipient, as the observer will not be able to decrypt the portion relating to the digital asset M. This is because the encryption is performed based on specifically calculated keys that are related to the recipient.

In a third aspect, a method of increasing the privacy of transactions provided on a distributed ledger is provided. The third aspect is related to the first and second aspects when implemented by the sender, in that it relates to asynchronous or non-interactive transactions where the sender can send a message to the recipient without requiring to exchange any additional information with the recipient for this. The third aspect varies from the first and second aspects in that the method involves splitting a transaction (that is to be sent to an IP address of a recipient) involving a digital asset into at least two separate transactions, each having a respective output, i.e. UTXO. The method according to a third aspect when implemented by the sender includes the steps of obtaining a public key P1 for the recipient, and calculating a first public key P21 pertaining to a first transaction TX1, the first public key P21 based on the obtained public key P1. The first transaction TX1 is associated with a digital asset. The method includes computing a first payment destination address for the recipient based on the first public P21 key. In addition, the method also includes calculating a first session key K1, wherein the first session key K1 is based on the first public key P21 for the first transaction TX1, a first private key V21 associated with the first public key P21, as well as the public key P1 associated with the recipient. A data item M associated with the first transaction TX1 is then encrypted with the first session key K1, the data item M relating to the digital asset. The method then includes generating a first output script for the first transaction TX1 based on the encrypted data item M and the first payment destination address, and providing an unspent transaction output (UTXO) based on this first output script to the distributed ledger. In addition to the above, the method also includes calculating a second public key P22 pertaining to a second transaction TX2, where P22 is based on the obtained public key P1. The second transaction TX2 is associated with or identifies the UTXO of the first transaction TX1. In some example embodiments, this second transaction TX2 provides one or more of a transaction identifier, network identifier for the recipient and/or the data item M relating to the first transaction TX1. Similar to the process discussed above, the method includes computing a second payment destination address for the recipient based on the second public key P22 key, and also calculating a second session key K2. The second session key K2 is based on the second public key P22 for the second transaction, a second private key V22 associated with the second public key P22, as well as the public key P1 associated with the recipient. Thus, advantageously the public key of the recipient P1 is used in the computation of all further keys that are in turn used for ensuing the security as well as the privacy of IP transactions, as the public key P1 is never directly used. The method further includes encrypting the data item M associated with the first transaction TX1 with the second session key K2, generating a second output script based on the encrypted data item M and the second payment destination, and providing the second output script to the distributed ledger, wherein the second output script is a non-spendable output for the second transaction TX2.

Advantageously, the above method of the third aspect further increases the security as well as the privacy of IP transactions from a sender and a receiver by splitting a transaction for a digital asset into two separate transaction and encrypting each with a specifically calculated session key. Each transaction has respective and specific transaction IDs, output scripts, payment destinations etc. As a separate and different public key, which is a newly calculated one-time key, is used for each transaction to calculate a respective session key as well as a respective payment destination address for each transaction, even if a malign party was monitoring the distributed ledger to spy on transaction for the recipient, they would no longer be able to access a data item M or message relating to the digital asset from the transactions. Therefore, a malign party will not be able to access the data item M from any transaction in order to point to the other transaction. Even if somehow, one transaction is somehow deciphered, the other transaction of the split pair relating to the digital asset still cannot be deciphered as a different public key is used, and in turn a different session key for the encryption is used for the encryption.

The method according to first and/or second aspect when implemented by one or more processors or servers or a responsible host associated with a recipient includes the steps of providing a public key P1 associated with the recipient, the public key further associated with a certificate issued by a trusted authority. In some embodiments, this may be similar to a certificate authority used for public key infrastructure or may be a trusted third party associated with a key management system that is able to verify one or more keys by linking or binding them to a given entity. The method as implemented by the recipient then further includes the steps of querying or monitoring the distributed ledger for one or more unspent transaction outputs (UTXO) associated with the recipient. Responsive to detecting a UTXO associated with the recipient, whereby the detected UTXO pertains to a given transaction, the method includes calculating a private key V2 for the given transaction, the private key V2 associated with a public key P2 for the given transaction. The digital asset is then processed, or the transfer of the digital asset is then processed by the recipient by executing one or more output scripts in the detected UTXO to complete the given transaction. In some embodiments, completing the transaction indicates that the transaction is spent, wherein spending is carried out by executing the output scripts relating to the UTXO. Once spent or processed, the completed transaction in then stored or posted or written into the distributed ledger.

Advantageously, as discussed above for the sender, the method of the first and the second aspect facilitate secure IP transactions between a sender and a recipient, irrespective of whether IPv4 or IPv6 standards are used. The method as implemented by the recipient enables identifying and processing digital asset transactions to a network address in an asynchronous or non-interactive manner. Thus, advantageously the sender and the recipient do not have to be online or communicatively coupled to each other in order to process the transaction. Once it is provided to the distributed ledger, the recipient can query and process the transactions that are meant for it based on the above discussed method at any given time.

In some embodiments, the step of querying or monitoring the distributed ledger includes querying or monitoring for one or more UTXOs associated with the network identifier and/or a payment destination address of the recipient. Advantageously, this embodiment enables the transactions that are meant for a given recipient to be easily identified among a plurality of all other transactions written into the distributed ledger.

In some embodiments, the step of calculating the private key for the detected UTXO comprises obtaining or using a private key V1 associated with the recipient, this private key being part of a cryptographic key pair associated with the public key P1 of the recipient. As the method is implemented by the recipient, the private key V1 will be available for either encryption and/or decryption in combination with the public key P1. The method then includes computing the private key V2 for the given transaction based on the private key V1 of the recipient and a hash of a data item M associated with the given transaction, the data item M relating to the digital asset.

In some embodiments implemented by the recipient, the step of querying or monitoring the distributed ledger comprises monitoring the distributed ledger for one or more non-spendable outputs associated with the recipient, the one or more non-spendable outputs related to the detected UTXO. Advantageously, as mentioned above, the presence of such non spendable outputs such as the OP-RETURN output, facilitates identification of one or more UTXOs with spendable outputs for the recipient.

In some embodiments, the one of more UTXOs are provided to the distributed ledger by the sender according to the method as implemented by the sender in a non-interactive or asynchronous manner, as discussed above for the first and the second aspects.

In some embodiments, the method as implemented by a recipient for the first and second aspects includes the steps of calculating a session key K, wherein the session key is based on the public key and private key (for instance, these are the further calculated public key P2 for a transaction, and the associated private key V2 indicated above) associated with the given transaction, and a public key P1 associated with the recipient. The step of executing one or more output scripts includes decrypting the data item M associated with the given transaction in the one or more output scripts using the session key K1, the data item M relating to the digital asset.

Advantageously, the above discussed embodiments serve to increase the privacy of the data included in transactions that are provided to the distributed ledger by the sender for the recipient. This advantageously further increases the security of IP transactions involving digital assets by using specifically calculated session keys to decrypt a portion of the data that has been encrypted using the same or a corresponding session key when sent by the sender.

In relation to the third aspect as discussed above for enabling increased privacy for one or more IP transactions between a sender and a recipient where a given transaction for a digital output is split up into two transactions, the method of the third aspect as implemented by the recipient comprises the steps of: providing a public key P1 associated with the recipient, the public key P1 further associated with a certificate issued by a trusted authority. The method includes querying or monitoring the distributed ledger for one or more unspent transaction outputs UTXO associated with the recipient. Responsive to detecting at least one UTXO associated with the recipient, whereby a detected UTXO is one among the at least one UTXOs pertains to a given transaction, the method further comprises calculating a private key V2 for the given transaction, the private key V2 associated with a public key P2 for the given transaction. In some embodiments, the public key P2 is that which is provided by the method implemented by the sender for the third aspect, as discussed above. The method then includes calculating at least one session key K1, K2 wherein the session key is based on the public key and private key P2, V2 associated with the given transaction, as well as the public key P1 associated with the recipient. In some embodiments, the session keys are the same or correspond to the keys that are calculated by the sender for each given transaction. The method then includes decrypting a data item M associated with the given transaction in the detected UTXO using the session key K1, K2, wherein the data item M either includes or relates to a digital asset. The method includes executing one or more output scripts in the detected UTXO based on the decrypted data item M to complete the given transaction and storing the completed transaction in the distributed ledger.

In some embodiments, the step of detecting at least one UTXO includes detecting two UTXOs associated with the recipient, each UTXO relates to a respective transaction, and each UTXO is associated with the encrypted data item M. One of the UTXOs is non-spendable output, such that said non-spendable output is then used for identifying the other UTXO associated with a spendable output for a transfer of the digital asset on the distributed ledger.

The above method as implemented by the recipient have similar and complementary advantages as with the method of the third aspect as implemented by the sender, i.e. to implement and enable an IP transaction (to a network address or identifier) in an asynchronous manner with increased security as well as increased privacy by using a plurality of transactions instead for transfer of a digital asset (which may be a plurality of digital assets) from a sender to a recipient. Since there are different public keys being calculated, based on which payment destination addresses as well as session keys are calculated for each transaction, and given that both transactions need to be decrypted and processed for the digital asset, it is increasingly difficult for a malign party to be able to intercept both the transactions to wrongfully obtain access to the digital asset.

In some embodiments, relating to the first, second and/or third aspect, the method as implemented by the recipient further includes creating a record for the recipient in a database relating to a plurality of network identifiers, and updating or including an entry in the record with a security indicator associated with the network identifier of the recipient. The security indicator being provided for verifying the authenticity of the network identifier. In some embodiments, the database may be a directory, such as a global directory like the DNS as mentioned above. The record may be a text or a service record, and the security indicator may be an entry or a flag confirming if the network identifier, such as the domain name, of the recipient implements one or more security protocols that are operable with at least one of IPv4 or IPv6.

A fourth aspect of the present disclosure, when implemented by one or more processors associated with a sender, relates to a method comprising the steps of obtaining a network address for the recipient, said network address being generated in combination with a public key for the recipient and a digital signature. In some embodiment, this network address may be a cryptographically generated address (CGA) or an advanced cryptographically generated address (CGA++) as discussed above. However, the disclosure is not limited to the presence of a CGA. Any network address that is associated with a cryptographic key pair for use in verifying the identity of the recipient can be used. In some embodiments where CGA or CGA++ is used for the network address, the method is operable using the IPv6 standard Internet protocol for communications over the internet. In some embodiments, the use of IPv6 address are considered for this aspect as Internet Protocol Security (IPSEC) protocol is default/mandatory on IPv6. This is not the case for IPv4 addresses and therefore IPv4 addresses are not cryptographically generated. IPSEC is an Internet suite protocol to authenticate and encrypt packets. IPSEC is used in virtual private networks (VPNs) to extend private networks across the public internet. While IPSEC works with both IPv4 and IPv6 addresses, it is optional with IPv4 however a mandatory one with IPv6. The method of the fourth aspect further includes, determining that the network address can accept digital assets, and responsive to said determination being successful, establishing a secure communication channel between the sender and the recipient. In some embodiments, the secure channel is provided based on authentication that is already provided by the digital signature based on the cryptographic key pairs used to generate the network. The method then includes requesting a payment destination address from the recipient's network address, and responsive to obtaining the payment destination, generating an output script for a transaction pertaining to a digital asset. The output script is then sent to the payment destination address. In some embodiments, the payment destination provided from the recipient is a one-time or single use payment destination address.

Advantageously, the fourth aspect of the present disclosure increases the security of IP transactions involving digital assets, where the transactions are synchronous or interactive, i.e. when both sender as well as recipient are online and in communication with each other to pass data that is needed by either party in order to facilitate the transfer of the digital asset to a network address, i.e. an IP address, for the recipient. This method is suitable for implementation when a response is required by a party, so that another party or entity may use the response for the transaction. Advantageously, the fourth aspect proposes that the recipient has a network address that is either cryptographically generated or otherwise pre-linked or verified to be associated with the recipient, such that it can be trusted that a public key P1 associated with the network address is indeed the public key P1 for the recipient. This enables a secure communication channel to be established for further messages relating to a payment destination address. Advantageously, since the sender and the recipient are online, and given that a single use payment destination address is sent via a secure i.e. authenticated/verified channel, the security of an IP transaction involving a digital asset is further increased.

In some embodiments, the one-time payment destination address is hash of a one-time public key for the digital asset, i.e. a pay to public key hash (P2PKH) address that relates to the recipient. In some embodiments, for added security, the payment destination address may be based on a common secret or generator value that is known to the sender and recipient, as discussed above in the first or second aspects. As with the above aspects, the public keys referred herein are keys relating to the ECDSA standard.

The fourth aspect, when implemented by one or more processors associated with a receiver provides a method, where responsive to an enquiry from the sender, the method includes the steps of providing a network address of the recipient for accepting digital assets, the network address being generated in combination with a public key P1 for the recipient and a digital signature. The method includes establishing a secure communication channel between the sender and the recipient. This is established in communication with the sender, as set out above. The method includes generating a one-time payment destination addresses for the recipient, sending the payment destination address to the sender, obtaining an output script for a transaction pertaining to a digital asset from the sender, and processing a payment relating to the digital asset. Once processed, a completed transaction based on the processed payment for the distributed ledger.

The fourth aspect (sender and recipient implementations) relates to a synchronous technique, where the sender and receiver are in communication with each other in order for a transaction to be processed, as mention above. As with the first and second aspects, in some embodiments related to the fourth aspect a public transaction template can be used for the recipient, instead of a public cryptographic key, for generation of a payment destination. In some embodiments, such public template may be a custom locking script generated by or provided by the recipient in response to the request for a payment destination by the sender, instead of a P2PKH. As the sender obtains a custom that is generated for the transaction in response to the destination request, this facilitates a synchronous or interactive communication flow for the digital asset transaction.

The advantages of the fourth aspect are already discussed above for implementations where the sender and the recipient are in communication (online and interactive) for processing the digital asset.

In some embodiments relating to the fourth aspect, the secure communication channel is established by deriving a session key for encrypting all communications sent to and/or received from the recipient. Such derivation may take place at the sender and/or the recipient. Advantageously this provides added security as well as privacy to IP transactions that are passed via the secure communication channel.

In a fifth aspect of the present disclosure, a method for transfer or payment of digital assets to a recipient identifier is provided, rather than a network address or end point like a CGA or a CGA++ address. In some embodiments, the recipient identifier may be a network identifier, such as a domain name. In other embodiments, the recipient identifier may be an identifier for a responsible host or server that provides a service on behalf of the recipient. For example, this may be indicated in a DNS service record that is associated with the recipient. Thus, any entity or host that that identifies or is associated with the recipient may be a recipient identifier. For ease of reference, the recipient identifier will be considered to be a domain name henceforth but is not so limited. In some embodiments, the method is operable with the IPv6 standard. The method of the fifth aspect when implemented by one or more processors associated with the sender comprises the steps of querying a database based on the network identifier of the recipient to resolve a network address for the recipient, wherein the network address being associated with a public key for the recipient, wherein the database is associated with the communication network. In some embodiments, the network address resolved is an IPv6 CGA or a CGA++ address. In some embodiments, the network address is the domain name for the recipient, such that the network address can be resolved by checking a directory such as the DNS for a record associated with the domain name. The method includes verifying that the network identifier of the recipient corresponds to a network identifier associated with the resolved network address for the recipient. In some embodiment, this may include checking for an entry in the directory that a security protocol such as DNSSEC etc is being used for the recipient, or an indication of a mechanism for binding a public key to the recipient. Responsive to the verification being successful, the method according to the second to fourth aspects can be carried out for a given transaction, once the CGA or CGA++ has been identified and verified.

Advantageously, the fifth aspect enables secure transactions involving a digital asset based on a network identifier such as a domain name for the recipient, rather than an IP address. Thus, digital payment can be made securely based on the domain name for the recipient, as long as the recipient is associated with a secure network address, such as a CGA or CGA++ that operates based on the IPv6 standard. Once the address has been resolved and verified, interactive or non-interactive IP transactions can be pursued based on the second to fourth aspects, thereby providing the same advantages of added security as well as privacy for domain name-based transfer of digital assets.

In some embodiments related to the fifth aspect, the network identifier is provided in an extension field associated with the network address. In some embodiments, when the identifier is a domain name and the network address is a CGA or CGA++ address, the domain name of the recipient is matched with the domain name this is present in an extension fields parameter, i.e. the extFields CGA parameter, for the step of verification, as an added security measure.

In some embodiments, the present disclosure relates to a computing device that can operate as either the sender or the recipient, the computing device including a processor, and memory including executable instructions that, as a result of execution by the processor, causes the system to perform the methods of any of the above discussed aspects.

In some embodiments, the present disclosure relates to a system that includes a sender and a recipient, each being an entity such as a computing device that are communicatively coupled to each other via a communication network for facilitating communication between at least one sender entity and at least one recipient entity.

In some embodiments, a computer-readable storage medium is provided, having stored thereon executable instructions that, as a result of being executed by a processor of a computer system, cause the computer system to perform the method of the aspects and/or the embodiments discussed above.

First Aspect—Sending Asynchronous IP Transactions Using IPv4

Although Internet Protocol Security and Extensions for IPv4 are available, they are limited and insufficient for digital asset transfers. Domain Name System Security Extension (DNSSEC) and Transport Layer Security (TLS) rely heavily on CAs and a PKI to provide authentication between the two communicating entities and protect against MITM attacks. However, as mentioned above, IPv4 32-bit addresses suffer from a limitation in terms of the space of possible addresses, which necessitates the re-use and remapping of addresses and therefore reduced security. Hence, transfer of digital assets pertaining to a distributed ledger are not presently implemented as IP transactions using IPv4 addresses. For instance, this is the case for Bitcoin transactions, where although IP transactions were proposed in theory, such functionality was not pursued in view of at least the above limitations in relation to security and scalability for IPv4 addresses to be used as payment destination addresses for entities communicating over the Internet.

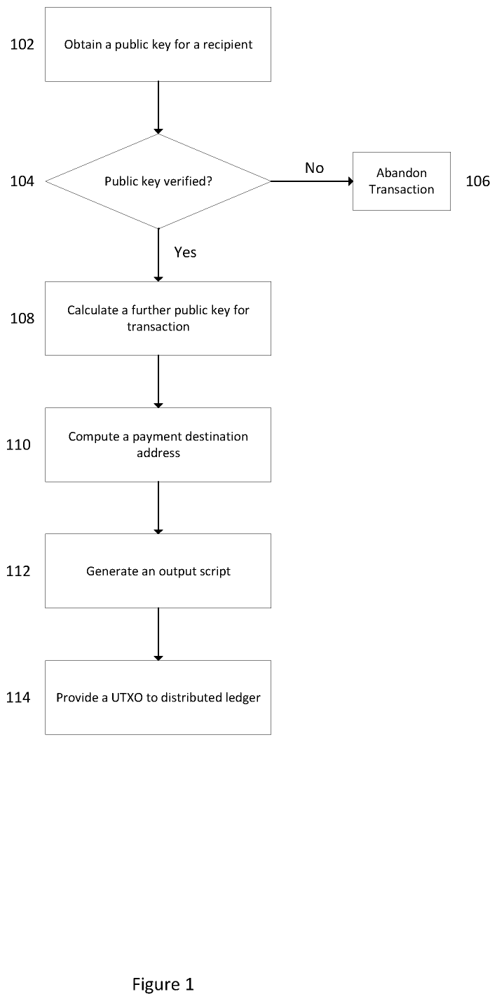

FIG. 1 relates to the first aspect of the present disclosure, when implemented by one or more processors implemented by a sender, where the sender sends a payment directly to a recipient, which may be represented by a network (IP) address for server or node, or a domain name related to an IP address, without using any payment server or wallet ecosystem for manipulation of public keys and payment destination addresses like the Bitcoin addresses. FIG. 1 represents the first aspect where transactions are handled or processed asynchronously, where the sender does not interact with the recipient for processing a digital asset transfer. Hereinafter the reference to a payment is understood to mean transaction or a transfer of a digital assets, such as but not limited to a token or a cryptocurrency. As discussed above, the sender may be an entity, i.e. a node or a computing resource that is associated with one or more processors. The sender may be implemented as a client entity or a server entity.

FIG. 1 is a flowchart that is concerned with implementing one or more IP transactions involving a digital asset that is to be transferred from a sender to a recipient over the Internet using the IPv4 standard for Internet Protocol communication. In other words, the method proposed in relation to FIG. 1 proposes a new protocol for the implementing payments, i.e. a transfer of a digital asset, to a recipient entity that uses a 32-bit IPv4 address. In the embodiment depicted in FIG. 1 it is considered that the recipient IPv4 address possesses some form of certification or authentication, though a Certificate Authority (CA) using a Public Key Infrastructure (PKI). Typically, with IPv4 this authentication can be done through two primary methods: DNSSEC and SSL/TLS, and the proposed method of FIG. 1 as implemented by the sender (entity) according to a first aspect, operates in combination with such existing security extensions that is inbuilt with IPv4, thereby ensuring scalability of the method for all nodes that use IPv4 addressing.

Step 102 relates to obtaining a public key P1 for the recipient. Although the embodiment in FIG. 1 discusses embodiments based on a public key, the disclosure is not so limited as discussed above. The use of a public template based on which a payment destination can be generated is also possible. The sender wishing to make a payment to the recipient may know or be provided with a network identifier for the recipient, which may be either the IP address or the domain name of the recipient. In embodiments where the domain name is known, this step may be implemented by the sender making a DNS query for a DNSKEY record to get the recipient's domain's zone key, which serves as the public key P1 the recipient. The public key is part of a cryptographic key pair for the domain of the recipient, which also includes a private key V1. V1 is usually a private signing key associated for the domain, and it is not shared. In embodiments where the IP address is known instead, a reverse DNS (rDNS) lookup query may be issued by the sender to identify the domain name associated with the IP address by querying for a pointer (PTR) record, before the public key P1 can be obtained for the domain.

In the present embodiment, the public key P1 that is obtained is understood to be a stable elliptic curve digital signature algorithm (ECDSA) public key. The ECDSA public key will be a valid point on the secp256k1 curve, compressed, and hex-encoded. In some embodiments, this means that the string length may be 66 bytes long (33 bytes binary, each byte encoded as two hex characters

In step 104, it is then verified whether the public key P1 is a valid key for the recipient, i.e. if it is indeed associated with the network identifier of the recipient. In some embodiments, verification is based on existing security extensions associated with IPv4, i.e. whereby the network identifier and associated key can be certified by using DNSSEC or TLS so that the public key P1 can be bound to the recipient. In some embodiments where the network identifier is a domain name, in order to confirm if a security extension such as DNSSEC is being used for the recipient's domain, a text record DNS TXT may be provided to indicate or signal that the domain is using DNSSEC for validating that the public key P1 does indeed belong to the recipient. If DNSSEC based authenticated is used, the public zone signing keys and key signing keys may be used for authenticating recipient, and this may be based on CA. The protocol is not explained in detail herein, as it relates to a known concept that is utilised for a part of the first aspect.

In embodiments where the network identifier is an IP address instead a domain name, this verification step may be carried out using SSL/TLS based authentication. The TLS protocol, and its predecessor Secure Sockets Layer (SSL), are cryptographic protocols that facilitate encrypted Internet communications, where a handshake protocol is implemented for a key exchange mechanism for such authentication.

If the public key cannot be verified in step 104, or if for instance security extensions for IPv4 such as DNSSEC or TLS are not being used by the recipient, then the transaction for the digital asset payment is abandoned in step 106.

Responsive to the verification being successful in step 104, step 108 relates to calculating a further public key P2 pertaining to the transaction. In some embodiments, the further public key P2 is calculated based on the recipient's public key P1 and the digital asset payment to be made to the recipient. In other words, the further public key is a one-time key that is specific to a given transaction being made by the sender. As discussed above, this is advantageous as it further increases security against attacks such as MITM and message replay by a malign party or impersonator.

For instance, in some embodiments the further public key P2 in this step can be is calculated based on the below equation:

P2=P1+SHA256(M)×G

Where:

The message M may be a data item related to the digital asset payment, or alternatively represent a value of a token etc. The data item may be part of the transaction or may be part of an identifier of the transaction. The location for the data item M is not limited to a particular field, as long as there is an association between the digital asset being transferred for the particular transaction from the sender being represented by the data item M.

In the above equation and embodiment, a SHA (Secure Hash Algorithm) is shown as an example to calculate a hash of data item M. The embodiment is not limited to SHA and a number of other cryptographic hash functions or a concatenation of a partial hash can also be used. A cryptographic hash is like a signature for a text or a data item. SHA-256 is one of the successor hash functions to SHA-1 and is one of the strongest hash functions available. SHA-256 algorithm generates an almost-unique, fixed size 256-bit (32-byte) hash. The hash in this example is a one-way function. This makes it suitable for password validation, challenge hash authentication, anti-tamper, digital signatures etc. In the present embodiment, calculating the hash of the data item M representing the digital asset significantly improves the security of transactions made directly to an IP address. In addition, calculation of the further public key P2 also facilitates the secure and asynchronous processing in this embodiment.

In the above equation and embodiment, G refers to a common secret may be used for cryptography to enable secure communication between two nodes based on the ECC standard. Standards for ECC may include known standards such as those described by the Standards for Efficient Cryptography Group (www.sceg.org). Elliptic curve cryptography is also described in U.S. Pat. Nos. 5,600,725, 5,761,305, 5,889,865, 5,896,455, 5,933,504, 6,122,736, 6,141,420, 6,618,483, 6,704,870, 6,785,813, 6,078,667, 6,792,530. The sender may send, over the communications network such as the Internet, a notice indicative of using the common ECC system with a common generator (G) to the recipient, or the sender and recipient may have previously settled on a common ECC system and using the common generator (G). In one example, the common ECC system may be based on secp256K1 which is an ECC system used by Bitcoin. The common generator G may be selected, randomly generated, or assigned. In the equation shown above, an elliptic curve point multiplication of the secure hash of data item M with the generator G is considered.

In step 110, a payment destination address is computed based on the further public key P2 calculated in step 108. In some embodiments, the payment destination is a Pay to Public Key Hash (P2PKH) value that is obtained by applying a double hash function of the further public key P2. For example, the HASH160 of the public key P2 can be obtained, which is then subjected to base 58 encoding in order to get the P2PKH value to send the payment to.

For example, given a public key of 027c1404c3ecb034053e6dd90bc68f7933284559c7d0763367584195a8796d9b0e, a P2PKH output script for the same may be hex-encoded as: 76a9140806efc8bedc8afb37bf484f352e6f79bff1458c88ac.

As discussed above, as the P2PKH value based on then one time further public key P2 significantly increases security, as MITM attacks will be very hard to implement based on the one-time and transaction specific public key for the recipient, as the obtained recipient public key P1 from step 102 is never directly used.

In embodiments where a public template is used for the recipient, then instead of a P2PKH, a custom locking script may be used instead based on the template for the recipient.

In step 112, an output script for the given transaction is generated based on the payment destination in step 110. The output script includes the digital asset to be transferred to the recipient. In some embodiments, the output script may include the, or a reference to, the network identifier of the recipient.

Various possible types of output script may be generated, but for ease of explanation, the Pay to Public Key Hash (P2PKH) output script generation is discussed in the following example.

This can be broken down as follows:

76; OP_DUP

a9; OP_HASH160

14; Push the next 20 bytes on to the stack

08 06 ef c8; ripemd160 (sha256 (compressed_public_key))

be dc 8a fb

37 bf 48 4f

35 2e 6f 79

bf f1 45 8c

88; OP_EQUALVERIFY

ac; OP_CHECKSIG

In some embodiments, an additional non-spendable output is also generated, with a reference to the data item M and the network identifier. As mentioned above, this non-spendable output facilitates transactions to be handled in an asynchronous manner, where the sender and the recipient do not need to be in communication with each other. For example, this can be an OP_RETURN output of the form

OP_RETURN <IP_TX prefix> <network_identifier> M

Where the Transaction prefix or ID and/or the network identifier can be used when querying the distributed ledger for transactions or types of transaction relating to the recipient. M represents the data item discussed above relating to the digital asset.

In step 114, an Unspent transaction output (UTXO) associated with the output script for the digital asset transaction in step 112 is provided to or posted to the distributed ledger, i.e. the blockchain.

For example, the outputs of a given transaction (TxID) from the sender to the recipient provided to the distributed ledger can be seen below.

TxID

| Inputs | Outputs |
|---|---|
| <Sig P1> <P1> | OP_RETURN <IP_Tx prefix> <Domain_Name> <M> |
| | OP_DUP OP_HASH160 <H(P2)> OP_EQUAL |
| | OP_CHECKSIG |

Accordingly, payments or transactions for the recipient can be processed asynchronously by the recipient checking for transactions for the recipient. For instance, by checking the OP_RETURN field with the TX_ID prefix or network identifier.

Second Aspect—Sending Asynchronous IP Transactions Using IPv6

IPv6 attempts to address a number of limitations with IPv4, and especially limitations in Public Key Infrastructure (PKI) techniques that this protocol relies on heavily. For example, Cryptographically Generated Addresses (CGA) can be used for authenticating public keys associated with IPv6 addresses. A CGA is a self-certifying address and is used for binding a public key to an IPv6 address, without the need for a CA or PKI. It is an IPv6 address that is cryptographically derived from a public-private cryptographic key pair. The address is thus cryptographically linked to a public-private key pair, so that verifying correct generation (self-certification) of the CGA can be guaranteed to a certain degree of security that such link is valid.

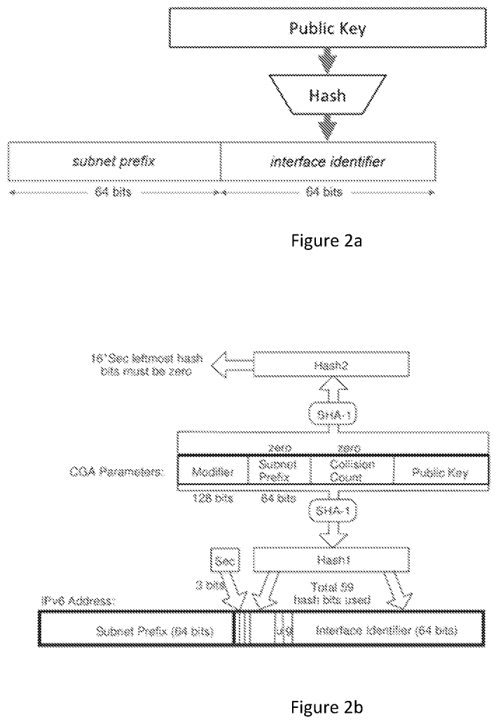

The basic principle involved in generating a CGA is shown in the FIG. 2a. The most significant 64 bits of the IPv6 address are reserved for the subnet and is referred to as the subnet prefix. The least significant 64 bits are generated from a cryptographic hash of a public key of the address owner and is referred to as the interface identifier. This basic CGA scheme had its security enhanced through the use of two different hashes and a ‘proof of work’ method (similar to mining) to make it much harder for an adversary to attack. This relies on a Sec parameter that a first hash is based upon. The higher the value of this security parameter, the more the difficulty of the first hash is required (similar to mining difficulty), making address generation and verification more complex. This enhanced version of CGA address generation can be seen in FIG. 2b.

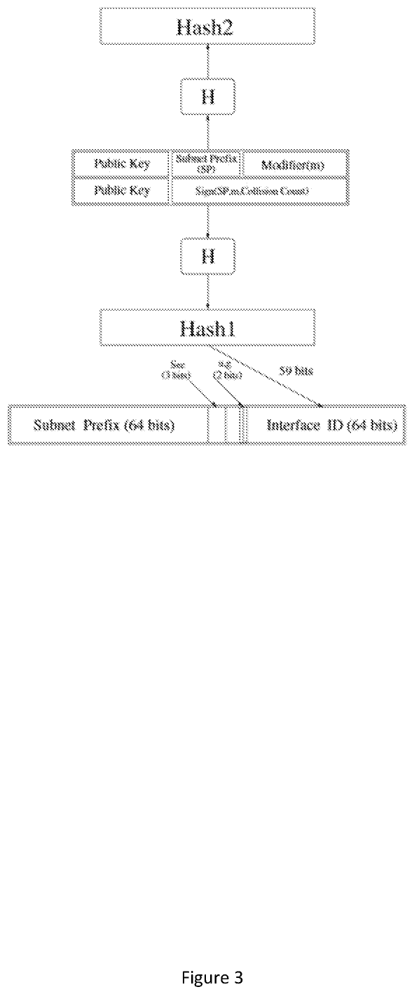

However, CGA does suffer from some limitations relating to security, when an asynchronous or non-interactive communication methodology is considered, making it not suitable or useful for IP address-based transactions when a digital asset is involved. Of these limitations are garbage attacks, message replay attacks, or the time-memory trade-off attacks by malign parties with access to a public key that is used to generate a CGA. This can have significant consequences when the IPv6 address is being one used to send a digital asset transaction. In order to address these limitations, a new protocol based on CGA, i.e. advanced CGA denoted by CGA++, was proposed in 2009. The difference from CGA is mostly an introduction of a signature by a private key into a hash function used to generate the IPv6 address in CGA++. In other words, authentication is incorporated into the address generation and verification, as opposed being an external process. CGA++ is depicted graphically in FIG. 3.

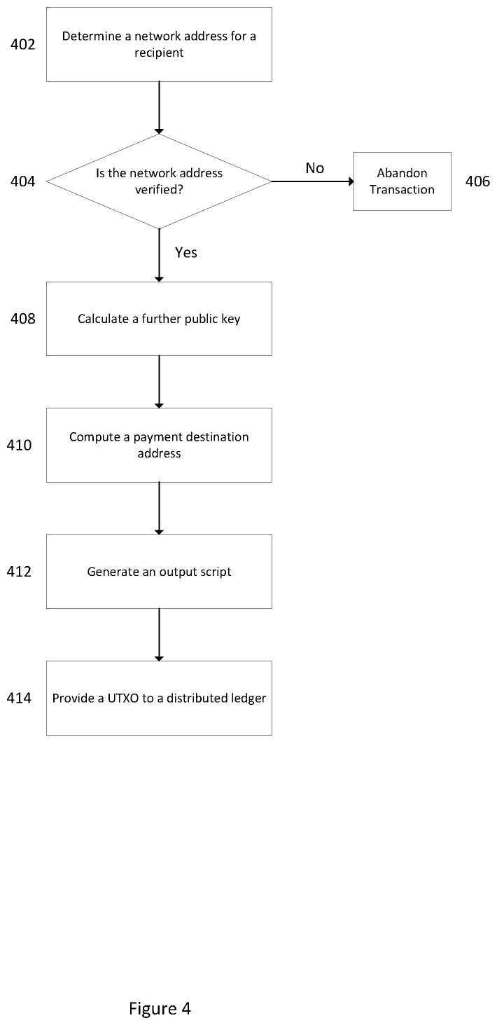

FIG. 4 relates to the second aspect of the present disclosure, when implemented by one or more processors implemented by a sender, where the sender sends a payment directly to a recipient, which may be a represented by a network identifier, i.e. domain name or an IP address, without using any payment server or wallet ecosystem for manipulation of public keys and payment addresses. FIG. 4 represents the second aspect where transactions are handled or processed asynchronously, where the sender does not interact with the recipient for processing a digital asset transfer.

FIG. 4 is a flowchart that is concerned with implementing one or more IP transactions involving a digital asset that is to be transferred from a sender to a recipient over the Internet using the IPv6 standard for Internet Protocol communication. In other words, the method proposed in relation to FIG. 1 proposes a new protocol for the implementing payments, i.e. a transfer of a digital asset, to a recipient entity that uses an IPv6 address. As mentioned above, an IPv6 address can be a CGA or a CGA++ address.

Step 402 relates to obtaining a network address for the recipient. The sender wishing to make a payment to the recipient entity may know or be provided with the IP address, i.e. the CGA or CGA++ address of the recipient. Given that these addresses are already associated with a public-private key pair, a public key P1 for the recipient is obtained based on the address. In the present embodiment, the public key P1 that is obtained is understood to be a stable elliptic curve digital signature algorithm (ECDSA) public key. Although the embodiment in FIG. 4 discusses embodiments based a public key, the disclosure is not so limited as discussed above. The use of a public template for the recipient for digital asset transactions, based on which a payment destination can be generated, is also possible. It will be understood that this public key P1 in this embodiment is not limited to a cryptographic key. For ease of reference though, FIG. 4 refers to an embodiment using public key P1.

In step 404, it is then verified whether the network address has been validly generated for the recipient, i.e. if it is generated based on a public key that is indeed associated with the recipient. CGA verification can be carried out based known processes for verification. As mentioned above, this may be based on an external CA, or in the case of CGA++ it may be an internal authentication process that is linked with the address generation.

If the network address for the recipient cannot be verified in step 404, then the transaction for the digital asset payment is abandoned in step 406.

Responsive to the verification being successful in step 404, step 408 relates to calculating a further public key P2 pertaining to the transaction. In some embodiments, the further public key P2 is calculated based on the recipient public key P1 and the digital asset payment to be made to the recipient. For instance, similar to step 108 in FIG. 1 relating to an asynchronous IPv4 transaction, in some embodiments relating to the second aspect for IPv6, the further public key P2 in this step can be is calculated based on the below equation:

P2=P1+SHA256(M)×G

Where M is a data item relating to the digital asset to be transferred and G is a common secret of generator for the transaction.

In step 410, a payment destination address is computed based on the further public key P2 calculated in step 408 for the IPv6 address. In some embodiments, as with step 110 of FIG. 1, the payment destination is a Pay to Public Key Hash (P2PKH) value that is obtained applying a double hash function of the further public key P2.

In step 412, an output script for the given transaction is generated based on the payment destination address in step 410. The output script includes a reference to the digital asset, i.e. a data item M that is also used for generating the further public key P2, to be transferred to the recipient. In some embodiments, the output script may include the, or a reference to a network identifier of the recipient, which may be the IPv6 address, i.e. the CGA or CGA++.

For instance, this output script may be represented as:

OP_DUP OP_HASH160<H (P2)> OP_EQUAL OP_CHECKSIG

In some embodiments, an addition non-spendable output is also generated, with a reference to the data item and the network identifier. For example, this can be an OP_RETURN output of the form, as discussed above in relation to step 112 of FIG. 1.

OP_RETURN <IP_Tx prefix> <IPv6_CGA (++)> <M>

where the Transaction prefix or ID and/or the network identifier can be used when querying the distributed ledger for transactions or types of transaction relating to the recipient. M represents the data item relating to the digital asset.

In step 414, an Unspent transaction output (UTXO) associated with the output scripts for the digital asset transaction in step 412 is provided to or posted to the distributed ledger, i.e. the blockchain.

For example, the outputs of a given transaction (TxID) from the sender to the recipient IPv6 address can be seen below

TxID

| Inputs | Outputs |
|---|---|
| <Sig P> <P> | OP_RETURN <IP_Tx prefix> |
| | <IPv6_CGA (++)> <M> |
| | OP_DUP OP_HASH160 <H(P_{1P})> |
| | OP_EQUAL OP_CHECKSIG |

Accordingly, payments or transactions for the recipient can be processed securely and asynchronously, being resilient to impersonation attacks such as MITM or message replay. The asynchronous operation can be implemented by the recipient checking for transactions for the recipient, for instance, by checking the OP_RETURN field with the TX_ID prefix or network identifier.

First and Second Aspect—Receiving Asynchronous IP Transactions Using IPv4 or IPv6

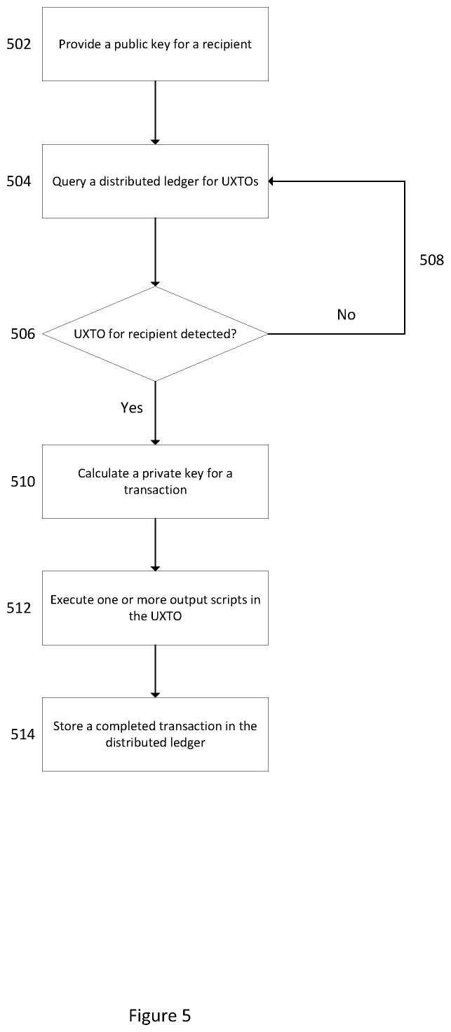

FIG. 5 relates to the first and the second aspect of the present disclosure, when implemented by one or more processors implemented by a recipient, where the recipient entity represented by a domain name or an IP address, has been sent a payment using the distributed ledger, and without using any payment server or wallet ecosystem for manipulation of public keys and payment addresses. FIG. 5 represents the first and second aspects where transactions are handled or processed asynchronously, where the sender and the recipient do not directly interact for processing a digital asset transfer. In some embodiments, transactions associated with a digital asset(s) are provided to the distributed ledger based on the methods as explained in relation to FIG. 1 or FIG. 4.

FIG. 5 is a flowchart that is concerned with implementing one or more IP transactions involving a digital asset transferred from a sender to a recipient over the Internet using the IPv4 or IPv6 standard for Internet Protocol communication. In other words, the method proposed in relation to FIG. 5 proposes a new protocol for the implementing payments, i.e. receiving a digital asset, by a recipient entity that uses an IPv4 or an IPv6 address.

Step 502 relates to providing or obtaining a public key P1 associated with the recipient. The public key P1 is further associated with a certificate issued by a trusted authority to confirm its validity and link to the recipient's IP address. In embodiments when an IPv4 address is being used, this may be based on a PKI and CA for authenticating the public key. If IPv6 addresses are used, the authentication of the public key P1 can be carried out internally (upon CGA generation) or eternally based on a trusted authority or signatory. Such step may in some embodiments be equated to accessing the public key, as it is related to the recipient. In the present embodiment, the public key P1 that is obtained is understood to be a stable elliptic curve digital signature algorithm (ECDSA) public key.

As discussed in above, the use of a public template for the recipient for digital asset transactions is also envisaged by the present disclosure, based on which a payment destination can be generated. In such embodiments, the public template may be generated by the recipient, and may include a custom locking script. For ease of reference though, FIG. 5 refers to an embodiment based on public key P1.

Step 504 relates to querying or monitoring the distributed ledger for one or more unspent transaction outputs (UTXO) associated with the recipient. As discussed above in relation to FIGS. 1 and 4, in some embodiments this can be performed by one or more servers or computing resources associated with the recipient by monitoring the additional non-spendable outputs, such as OP_RETURN for the recipient. In other embodiments, the recipient may also query the distributed ledger based on the transaction identifiers or network identifiers etc. There, the present embodiment is not limited to a particular field or output for identifying transactions for the recipient.

In step 506, the recipient detects the transactions or UTXO with the digital asset that is to be processed by the recipient, based on the results of step 504. If no UTXO is detected in step 504, it may mean that there are no transactions as yet directed to that recipient, and the step of querying and monitoring is repeated in step 508. The recipient, by querying the distributed ledger either periodically or randomly for transactions, enables processing of transaction asynchronously, without requiring any interaction with the sender. In some embodiments, detection may be based on detecting the non-spendable transactions, which in turn identifies the transaction for spending the digital asset.

In step 510, responsive to detecting a UTXO associated with the recipient, whereby the detected UTXO pertains to a data item M representing the digital asset in given transaction, a private key V2 is calculated. This private key V2 is associated with the further public key P2 that is calculated by the sender in either steps 108 of FIG. 1 or 408 of FIG. 4, and forms a cryptographic key pair P2, V2 for that particular transaction. In some embodiments, the private key V2 for the transaction detected is based on the recipient's own private key V1, i.e. the public key P1 and private key V1 in step 501. This is advantageous, as the payment destination address, i.e. the P2PKH, or indeed a custom script that was generated based on an embodiment where a public template is used, based on key P2 can only be deciphered or processed by the one-time calculated private key V2 that is based on the transaction as well as the recipient's own private key V1. V1 can either be the private key used to generate a CGA, or one that is used in a PKI arrangement, depending on weather IPv4 or IPv6 addresses are used.

In some embodiments, the private key V2 is calculated by the equation:

V2=V1+SHA256(M).

Therefore, computing the private key V2 for the given transaction is based on the private key V1 of the recipient and a hash of a data item M associated with the given transaction, the data item M relating to the digital asset.

In step 512, the transaction is processed, i.e. the digital asset payment is processed, by executing one or more output scripts in the detected UTXO to complete the given transaction as discussed in steps 112 and 114 of FIG. 1 or steps 412 or 414 of FIG. 4. For example, If OP_RETURN <IP_Tx prefix> <IPv6_CGA (++)> <M> is detecting for an IPv6 transaction as indicated in FIG. 4, then the scripts of the related UTXO OP_DUP OP_HASH160<H (P2)> OP_EQUAL OP_CHECKSIG will be executed to complete the digital asset transfer for the recipient.

In step 514, the completed transaction for the digital asset represented by data item M is then stored in or posted to the distributed ledger.

Accordingly, payments or transactions for the recipient can be processed securely and asynchronously, being resilient to impersonation attacks such as MITM or message replay based on the methods proposed in FIGS. 1, 4 and 5. The asynchronous operation can be implemented by the recipient checking for transactions, for instance by checking the OP_RETURN field with the TX_ID prefix or network identifier.

Third Aspect—Privacy for Asynchronous Transactions

With asynchronous IP transactions as discussed in the first and second embodiments, an unrelated observer may in theory be able to check or monitor the distributed ledger for OP_RETURN output messages, i.e. UTXO's, and link it to the actual transaction or UTXOs sent for a recipient for processing a digital asset payment. These outputs are not private on the distributed ledger since any observer may be able to access data item M, in the same way that a recipient may access the OP-RETURN non spendable transaction. Accordingly, the third aspect proposes a method to obscure the transactions to avoid prying by malign parties. In the third aspect, the transaction for the recipient with the digital asset, i.e. represented by data item M, is split into two different transactions and are separately obscured. The third aspect relates to both IPv4 as well as IPv6 IP addresses for the recipient.

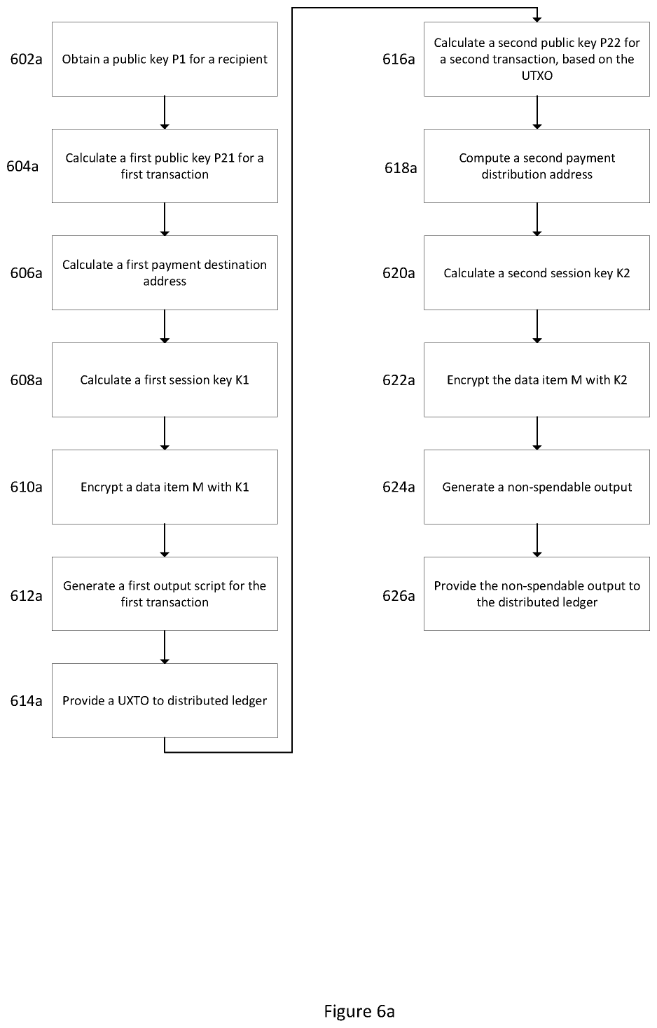

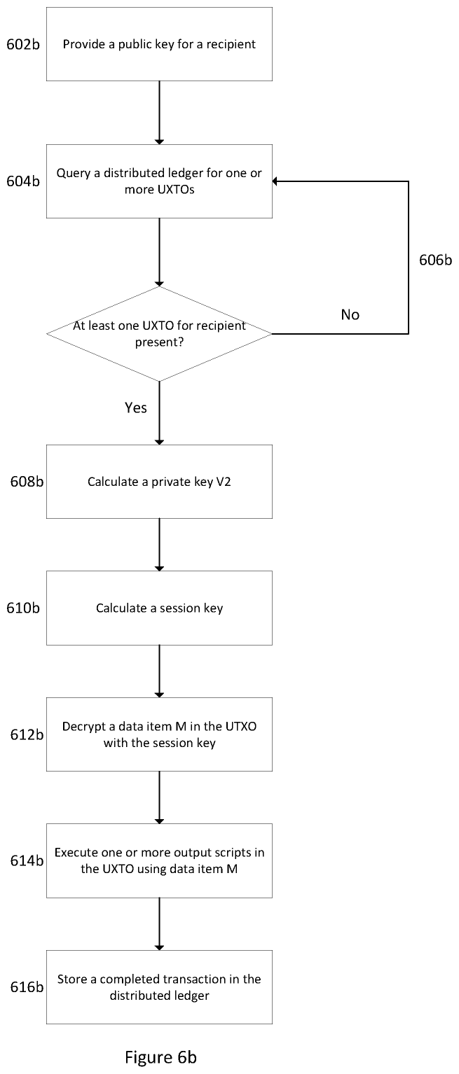

FIG. 6a, which relates to a method as implemented by a sender, discusses a method of increasing privacy for asynchronous IP transactions relating to a digital asset.

In step 602a, a public key P1 for the recipient is obtained, as already discussed for the first and second aspects.

In step 604a, a first public key P21 pertaining to a first transaction TX1 based on the recipient public key P1 is calculated. This first transaction may be associated with the digital asset represented by data item M. The first public key P21 may be calculated as discussed in either steps 108 of FIG. 1 or step 408 of FIG. 4.

In step 606a a first payment destination addresses for the recipient based on the first public P21 key is calculated for the first transaction TX1. This computation may be similar to that discussed in relation to step 110 of FIG. 1 or FIG. 410 of FIG. 4, to identify a P2PKH value as the payment destination address based on the recipient's network address.

In step 608a, a first session key K1 for TX1 is computed, wherein the first session key is based on the first public key P21 for the first transaction, a first private key V21 associated with the first public key P21 and the public key P1 associated with the recipient. Advantageously, this session key K1 can be used to obscure data pertaining to TX1 in a secure manner as it is related to one-time computed public keys, and never uses the original or obtained public key P1 of the recipient directly, making is harder for interception by malign parties Thus, K1 may be calculated by the equation

K1=V21×P1

In step 610a, data item M associated with the first transaction TX1 is encrypted with the first session key K1, and in step 612a, a first output script for the first transaction TX1 is generated based on the encrypted data item M and the first payment destination address from step 606a.

In step 614a, a UTXO based on the output script in step 612a is provided on the distributed ledger. For instance, for the first transaction TX1, the UTXO (output) may be as given below, where the network identifier can be either <IPv6_CGA (++)> if IPv6 is used or can be <Domain_Name> if IPv4 is used.

TX1

| Inputs | Outputs |
|---|---|
| <Sig P1> <P1> | OP_DUP OP_HASH160 <H(P21)> |
| | OP_EQUAL OP_CHECKSIG |

In step 616a, a second public key P22 pertaining to a second transaction TX2 based on the recipient public key P1 is calculated. TX2 is associated with or indicates or links to the UTXO of the first transaction TX1 shown above relating to the data item M.

In step 618a a second payment destination addresses for the recipient based on the second public P22 key is calculated for the second transaction TX2. This computation may be similar to that discussed in relation to step 110 of FIG. 1 or FIG. 410 of FIG. 4, to identify a P2PKH value as the destination address for TX2.

In step 620a, a second session key K2 for TX2 is computed, wherein the second session key is based on the second public key P22 for the second transaction, a second private key V22 associated with the second public key P22, and the public key P1 associated with the recipient. Advantageously, this session key K2 can be used to securely obscure data pertaining to TX2 in a secure manner as it is related to one-time computed public keys, and never uses the original key P1 of the recipient directly, making it harder for interception by malign parties. Thus, K2 may be calculated by

K2=V22×P1

Where K2=K1

In step 622a, data item M associated with the first transaction TX1 is encrypted with the second session key K2. Thus, the second transaction is related to the first transaction.

In step 624a, a second output script for the second transaction TX2 is generated based on the encrypted data item M and the second payment destination address from step 618a. The output script of the second transaction is a non-spendable output, i.e. an OP_RETURN that identifies the first transaction TX1.

In step 626a, a non-spendable based on the output script in step 624a is provided on the distributed ledger. The non-spendable output is shown below.

TX2

| Inputs | Outputs |
|---|---|
| <Sig P1> <P1> | OP_RETURN <IP_Tx prefix> |
| | <network Identifier> <Encₖ (M) > |

It will be understood that the order of the above discussed transactions TX1 and TX2 may be interchanged, and that the OP-RETURN may in some cases be indicated as the first transaction.

As explained above, the third aspect enables increased privacy by splitting the UTXO for an IP transaction based on a digital asset into two separate transactions, where each is obscured by a session key that can be calculated by the sender and is based on one-time generated public/private key pair pertaining to the respective transaction.

FIG. 6b also relates to the third aspect, but as implemented by one or more processors associated with a recipient.

Step 602b relates to providing a public key P1 associated with the recipient, the public key further associated with a certificate issued by a trusted authority.

Step 604b relates to querying or monitoring the distributed ledger for one or more unspent transaction outputs (UTXO) associated with the recipient. This is similar to step 504 of FIG. 5.

Similar to step 506 of FIG. 5, step 606b relates to detecting if at least one UTXO for the recipient is present in the distributed ledger. The UTXOs for the recipient are provided based on the method of FIG. 6a (see steps 614a and 626a).

In step 608b, responsive to detecting at least one UTXO associated with the recipient, whereby a detected UTXO among the at least one UTXOs pertains to a given transaction, a private key V2 (which may be V21 or V22 as discussed above) is computed for each transaction associated with the UTXO. This may relate to a private key being computed for each of TX1 as well as TX2 as set out in FIG. 6a. For simplicity only one private key V2 is discussed in FIG. 6a. In some embodiments, the private key V2 associated with a public key P2 for the given transaction. In some embodiments, this key may be computed in a similar manner as described in step 510 of FIG. 5.

In step 610b, a session key K1, K2 is calculated for each transaction TX1 or TX2, wherein the session key is based on the public key and private key P2, V2 associated with the respective transaction, and the public key P1 associated with the recipient. This calculation is similar to the calculation of session keys K1 as well as K2 discussed in relation to FIG. 6a.

In step 612b, the data item M related to the digital asset and associated with the given transaction in the detected UTXO (whether spendable UTXO or non-spendable OP_RETURN) is decrypted using the session key K1, K2. Thus, only the intended recipient will be able to calculate the session keys and decrypt the data item M in the transactions. For instance, the non-spendable TX2 OP_RETURN that links data item M to the data item in the UTXO for TX1 will have to be decrypted to identify M, which can only then in turn be used to identify the UTXO for TX1. Any other unrelated observer will thus not be able to link the two transactions to each other since they will not be able to decrypt the data item M.

Once decrypted, in step 614b, the one or more output scripts in the detected UTXO is executed, based on the decrypted data item M to complete the respective transaction, and in Step 616b, the completed transaction is stored in the distributed ledger.

Fourth Aspect—Synchronous or Online IP Transactions Using IPv6 Addresses

With the use of IPv6 Cryptographically Generated Addresses (CGA), authentication can be done as a feature of the way CGAs are generated and operated, as already discussed. The fourth aspect proposes that such “in-built” authentication can be extended to facilitate IP transaction for digital asset to provide confidentiality in a secure communication channel between sender and recipient.

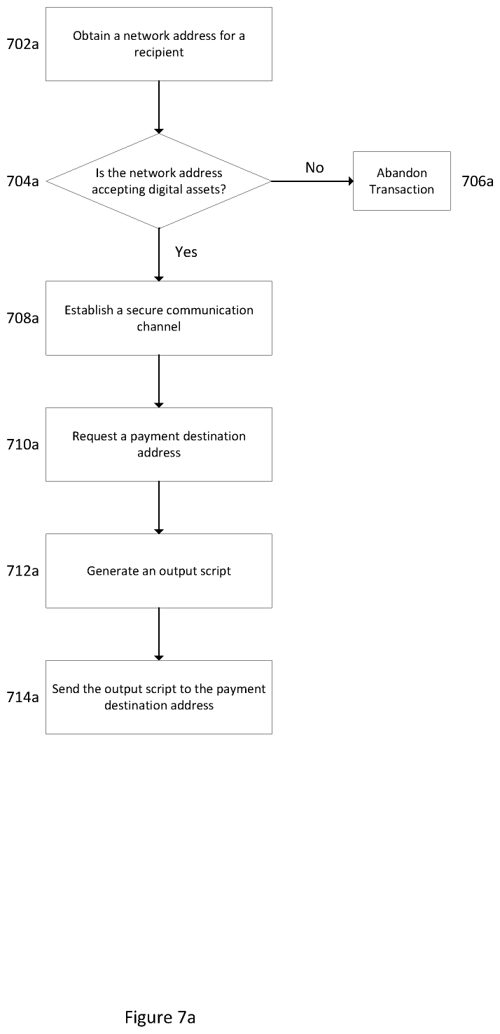

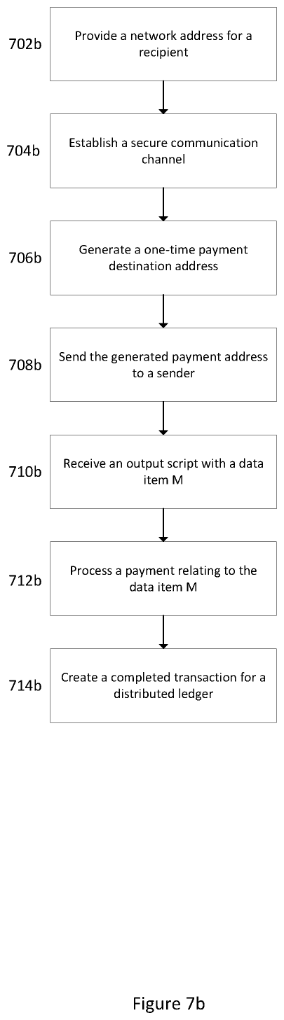

FIG. 7a discusses the method according to the fourth aspect when implemented by one or more processors associated with a sender.

Step 702a relates to obtaining a network address for the recipient, said network address being generated in combination with a public key for the recipient and a digital signature. In some embodiments, this step is similar to step 402a. The network identifier is a CGA or a CGA++ in this embodiment, where the public key P1 is part of the cryptographic key pair for the CGA. V1 may be the private key of the pair.

In step 704a, it is determined if the network address can accept digital assets. This may in some embodiments relate to detecting the presence of a flag or an identifier in a directory record, such as the DNS, for the recipient address that signals that the recipient can accept a digital asset based on it's CGA. If there is no such indication, or if there is an indication that the recipient address does not accept digital assets, then the process is abandoned in step 706a.

In step 708a, responsive to the determination in step 704a being successful, a secure communication channel is established between the sender and the recipient. In some embodiments, this is facilitated by IPSEC. IPSEC includes three main protocols: Security Associations (SA), Authentication Headers (AH), and Encapsulating Security Payloads (ESP). The SA protocol is used to provide the bundle of algorithms and data exchanges necessary for AH and/or ESP protocols. AH is used to guarantee authentication and integrity of the data sent, while ESP includes all that AH provides, in addition to providing confidentiality of the data. Either of AH or ESP may be used for the secure communication channel. Either AH or ESP may be used in step 708a. In some embodiments, this may be based on the keys P1, V1 relating to the CGA, which in some embodiment may be used to derive a session key K. In some embodiments, this derivation may be through Diffie-Hellman or RSA, for instance.

Step 710a relates to the sender expressly requesting a one-time payment destination address from the recipient via the established secure channel. This may be a request for a P2PKH address provided by the recipient, this being based on the IP address. Thus, the method is interactive in a secure manner, as such interaction is via a secure communication channel that is protected using a session key K. Although the embodiment in FIG. 7a discusses embodiments based a P2PKH destination based on a public key, the disclosure is not so limited. The use of a public template generated for digital asset transactions for the recipient based on which a payment destination can be generated, is also possible. It will be understood that this public key P1 in this embodiment is not limited to cryptographic key. For ease of reference though, FIG. 7a refers to embodiments using a public key.

In step 712a, responsive to obtaining the payment destination, an output script for a transaction pertaining to a digital asset is generated, similar to step 412 of FIG. 4.

In step 714a, the generated output script is then sent directly to the payment destination that was provided to the sender via the secure channel in step 710a.

FIG. 7b also discusses the fourth aspect of the present disclosure, but in relation to implementation by one or more processors associated with a recipient.

In step 702b, responsive to an enquiry from the sender, a network address of the recipient for accepting digital assets is provided, where the network address is a GCA being generated in combination with a public key P1 for the recipient and a digital signature. V1 may represent the private key related to P1.

In step 704b, a secure communication channel between the sender and the recipient is established. This may be similar to step 708a, i.e. based on a session key K.

Step 706b relates to generating a one-time payment destination addresses for the recipient. In some embodiments, this may be generated based on a one-time public key that is different to the public key P1 for the recipient. The destination address may be a P2PKH address. In step 708b, this address is sent to the sender over the secure communication channel. Although the embodiment in FIG. 7b discusses a P2PKH destination based on a one-time public key, the disclosure is not so limited. The use of a public template generated for digital asset transactions for the recipient, based on which a payment destination can be generated is also possible. For ease of reference though, FIG. 7b refers to embodiments using public key P1.

Step 710b relates to obtaining an output script for a transaction pertaining to a digital asset from the sender, where the output script is received at or associated with the payment destination address, directly.

Steps 712b relates to processing a payment relating to the digital asset by executing the output script received in step 710b, and in step 714b a completed transaction based on the processed payment is created for the distributed ledger.

Fifth Aspect—Domain Name Based IP Transactions for IPv6 Addresses

The fifth aspect considers a technique for sending a digital asset payment directly to a domain name or network identifier associated with an IPv6 address (CGA or CGA++). The fifth aspect proposes resolving an IPv6 address that maps to the domain name. Advantageously, the fifth aspect enables payment of a digital asset directly to a domain name or a recipient, rather than the IP address.

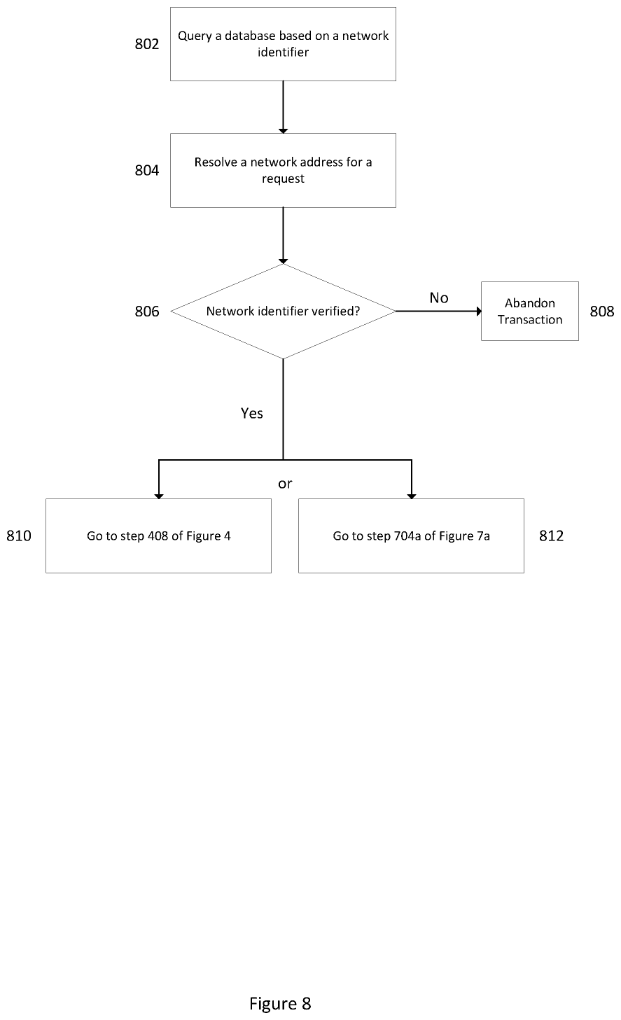

FIG. 8 discuss the fifth aspect in relation to its implementation by one or more processors associated with a sender.

Step 802 relates to querying a directory, such as a DNS, based on the network identifier, such as the domain name, of the recipient to resolve a network address for the recipient. In some embodiments, the network address is a CGA or CGA++ address being associated with a public key P1 for the recipient.

Step 804 relates to verifying that the network identifier of the recipient corresponds to a network identifier associated with the resolved network address for the recipient. In some embodiments, this relates to authentication of the recipient linked to the domain name. In some embodiments this may be verified by checking if the domain name in step 802 is the same as a domain name that is present in an extension field associated with the CGA that has been resolved in step 802.

In step 806, responsive to the verification in step 804 being successful, the method of the second aspect in FIG. 4 from step 404 onwards is performs for an asynchronous implementation, or the method of the fourth aspect in relation to FIG. 7a from steps 704a onwards is performed for an interactive implementation.

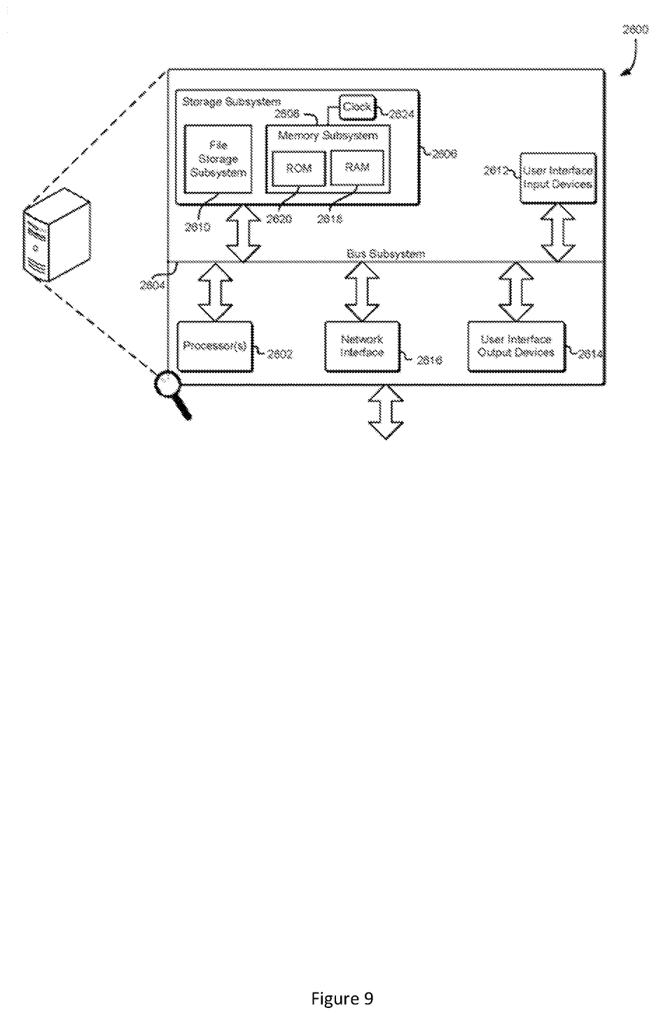

Turning now to FIG. 9, there is provided an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as an entity or a node such as the sender or the recipient entity, which may be implemented by or one or more processors, or to implement a host responsible for provision of a server for a sender or a recipient entity. Thus, computing device 2600 may be a portable computing device, a personal computer, or any electronic computing device. As shown in FIG. 9, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 9 is intended only as a specific example for purposes of illustrating the preferred embodiment of the device. Many other configurations having more or fewer components than the system depicted in FIG. 9 are possible.

### Enumerated Example Embodiments

The present disclosure is hereby discussed based on the following clauses that are related to the above aspects, which are provided herein as exemplary embodiments for better explaining, describing and understanding the claimed aspects and embodiments.

1. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource associated with a network identifier that is specific to said payment entity, the method comprising the steps of:
obtaining a public key P1 for the recipient;
verifying that the obtained public key P1 is associated with the network identifier of the recipient;
responsive to the verification being successful, calculating a further public key P2 pertaining to a given transaction based on the obtained public key, the given transaction associated with a digital asset;
computing a payment destination address for the recipient based on the further public (P2) key;
generating an output script for the given transaction based on the payment destination; and
providing an unspent transaction output (UTXO) based on the output script to the distributed ledger.

2. The method as set out in clause 1 wherein the output script includes a reference to the network identifier of the recipient.

3. The method as set out in any one of clauses 1 or 2 wherein the network identifier is a domain name of the recipient, said domain name being known to the sender, or being obtained from a network address of the recipient that is known to the sender.

4. The method as set out in any preceding clause wherein the obtained public key P1 is part of a cryptographic key pair that includes a private key V1, such that one or more records associated with network identifier are encrypted with the private key V1.

5. The method as set out in any preceding clause wherein the obtained public key P1 is digitally signed by a trusted authority (CA) to associate the obtained public key P1 to the network identifier of the recipient, and wherein the step of verifying the obtained public key P1 is performed based on another public key associated with the trusted authority.

6. The method as set out in clause 1 wherein the network identifier is a network address associated with the recipient, and wherein the obtained public key P1 is based on key exchange information associated with the network address.

7. The method as set out in clause 6 wherein the step of verifying the obtained public key P1 is performed based on a certificate issued by a trusted authority (CA) for the network address.

8. The method as set out in any preceding clause comprising:
accessing a directory relating to a plurality of network identifiers;
identifying a record associated with the network identifier of the recipient; and
verifying the authenticity of the network identifier based on a security indicator present in the record.

9. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:

determining a network address for the recipient, said network address being associated with a public key P1 for the recipient;

verifying that the network address is generated for, and is specific to the recipient;
responsive to the verification being successful, calculating a further public key P2 pertaining to a given transaction based on the public key for the recipient, the given transaction associated with a digital asset;
computing a payment destination address for the recipient based on the further public P2 key;
generating an output script for the given transaction based on the payment destination; and
providing an unspent transaction output (UTXO) based on the output script to the distributed ledger.

10. The method as set out in clause 9 wherein the output script includes a reference to a network identifier of the recipient.

11. The method as set out in any one of clauses 9 or 10 wherein the network address for the recipient is a cryptographically generated address (CGA) derived from a cryptographic key pair including the public key P1, and a corresponding private key V1 associated with the recipient.

12. The method as set out in clause 9 or 10 wherein the step of verifying the network address is based on a digital signature provided by a trusted authority (CA) for establishing a secure communication channel with the recipient.

13. The method as set out in any one of clauses 9 to 11 wherein the step of verifying the network address is based on a digital signature of the private key V2 that is included in a hash function used to generate the CGA for the recipient.

14. The method as set out in any preceding clause wherein the step of calculating a further public key P2 comprises:
applying a secure hash function to a data item associated with the given transaction M to obtain a result, the data item M relating to the digital asset to be provided to the recipient; and
associating the public key P1 for the recipient with the result.

15. The method as set out in any preceding clause wherein the step of computing the payment destination address includes computing a pay to public key hash (P2PKH) value based on applying a double hash function of the further public key P2, or wherein the step of computing a payment destination is based on a custom script associated with a public template for the recipient for digital assets transactions.

16. The method as set out in any preceding clause wherein the step of providing the UTXO to the distributed ledger includes providing an additional non-spendable output having a locking script including the network identifier or network address of the recipient for the given transaction.

17. The method as set out in any preceding clause comprising:
calculating a session key K1, wherein the session key is based on the further public key P2 for the given transaction, a private key V2 associated with the further public key and the public key P1 associated with the recipient;
encrypting a data item M of the given transaction with the session key K1, the data item M relating to the digital asset;
wherein the output script is generated based on the encrypted data item M.

18. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:
obtaining a public key P1 for the recipient;
calculating a first public key P21 pertaining to a first transaction TX1 based on the obtained public key, the first transaction TX1 associated with a digital asset;
computing a first payment destination address for the recipient based on the first public P21 key;

calculating a first session key K1, wherein the first session key is based on the first public key P21 for the first transaction, a first private key V21 associated with the first public key P21 and the public key P1 associated with the recipient;
encrypting a data item M associated with the first transaction TX1 with the first session key K1, the data item M relating to the digital asset;

generating a first output script for the first transaction TX2 based on the encrypted data item M and the first payment destination address;

providing an unspent transaction output (UTXO) based on the output script to the distributed ledger;

calculating a second public key P22 pertaining to a second transaction TX2 based on the obtained public key P1, the second transaction associated with the UTXO of the first transaction;
computing a second payment destination address for the recipient based on the second public P22 key;

calculating a second session key K2, wherein the second session key K2 is based on the second public key P22 for the second transaction TX2, a second private key V22 associated with the second public key P22 and the public key P1 associated with the recipient;
encrypting the data item M associated with the first transaction TX1 with the second session key K2;

generating a second output script based on the encrypted data item M and the second payment destination; and

providing the second output script to the distributed ledger, wherein the second output is a non-spendable output.

19. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing device associated with a network identifier that is specific to said payment entity, the method comprising the steps of:
Providing a public key P1 associated with the recipient, the public key further associated with a certificate issued by a trusted authority;
querying or monitoring the distributed ledger for one or more unspent transaction outputs (UTXO) associated with the recipient;
responsive to detecting a UTXO associated with the recipient, whereby the detected UTXO pertains to a given transaction, calculating a private key V2 for the given transaction, the private key V2 associated with a public key P2 for the given transaction;
processing a digital asset or processing a transfer of the digital asset by executing one or more output scripts in the detected UTXO to complete the given transaction; and
storing the completed transaction in the distributed ledger.

20. The method as set out in clause 19 wherein the step of querying or monitoring the distributed ledger includes querying or monitoring for one or more UTXOs associated with the network identifier and/or a payment destination address of the recipient.

21. The method as set out in any one of clauses 19 or 20, wherein the step of calculating the private key for the detected UTXO comprises:
obtaining a private key V1 associated with the recipient, the private key being part of a cryptographic key pair associated with the public key P1 of the recipient;
computing the private key V2 for the given transaction based on the private key V1 of the recipient and a hash of a data item M associated with the given transaction, the data item M relating to the digital asset.

22. The method as set out in any one of clauses 19 to 21 wherein the step of querying or monitoring the distributed ledger comprises monitoring the distributed ledger for one or more non-spendable outputs associated with the recipient, the additional outputs related to the detected UTXO.

23. The method as set out in any one of clauses 19 to 22 wherein the one of more UTXOs are provided to the distributed ledger by the sender according to the method as set out in any one of clauses 1 to 17.

24. The method as set out in any one of clauses 19 to 23 comprising:
calculating a session key K1, wherein the session key is based on the public key and private key P2, V2 associated with the given transaction, and the public key P1 associated with the recipient;
wherein the step of executing one or more output scripts includes decrypting a data item M associated with the given transaction in the one or more output scripts using the session key K1, the data item M relating to the digital asset.

25. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing device, the method comprising the steps of:
providing a public key P1 associated with the recipient, the public key further associated with a certificate issued by a trusted authority;
querying or monitoring the distributed ledger for one or more unspent transaction outputs (UTXO) associated with the recipient;
responsive to detecting at least one UTXO associated with the recipient, whereby a detected UTXO among the at least one UTXOs pertains to a given transaction, the method further comprises:

calculating a private key V2 for the given transaction, the private key V2 associated with a public key P2 for the given transaction;

calculating a session key K1, K2 wherein the session key is based on the public key and private key P2, V2 associated with the given transaction, and the public key P1 associated with the recipient;

decrypting a data item M associated with the given transaction in the detected UTXO using the session key K1, K2, wherein the data item M relates to a digital asset;

executing one or more output scripts in the detected UTXO based on the decrypted data item M to complete the given transaction; and
storing the completed transaction in the distributed ledger.

26. The method as set out in clause 25 wherein the step of detecting at least one UTXO includes detecting two UTXOs associated with the recipient, each UTXO relating to a respective transaction, and each UTXO being associated with the encrypted data item M; wherein one of the UTXO's is non-spendable output, such that said non-spendable output is used for identifying the other UTXO associated with a spendable output for a transfer of the digital asset.

27. The method as set out any one of clauses 19 to 26 comprising:
creating a record for the recipient in a directory relating to a plurality of network identifiers; and
updating or including an entry in the record with a security indicator associated with the network identifier of the recipient, said security indicator being provided for verifying the authenticity of the network identifier.

28. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:

obtaining a network address for the recipient, said network address being generated in combination with a public key P1 for the recipient and a digital signature;

determining that the network address can accept digital assets;

responsive to said determination being successful, establishing a secure communication channel between the sender and the recipient;

requesting a payment destination address or a public template from the recipient;
responsive to obtaining the payment destination, generating an output script for a transaction pertaining to a digital asset; and
sending the output script to the payment destination.

29. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:

responsive to an enquiry from the sender, providing a network address of the recipient for accepting digital assets, the network address being generated in combination with a public key for the recipient and a digital signature;

establishing a secure communication channel between the sender and the recipient;

generating a payment destination addresses or a public for the recipient;

sending the payment destination address to the sender;
obtaining an output script for a transaction pertaining to a digital asset from the sender; and

processing a payment relating to the digital asset; and

creating a completed transaction based on the processed payment for the distributed ledger.

30. The method as set out in clause 28 or 29 wherein the network address is a cryptographically generated address, and wherein the secure communication channel is established by deriving a session key for encrypting all communications sent to and/or received from the recipient.

31. The method as set out in any one of clauses 28 to 30 wherein the payment destination address is hash of a one-time public key for the digital asset (P2PKH).

32. The method as set out in any one of clauses 28 to 30 wherein public template includes a custom script generated for the recipient for obtaining a payment destination address associated with the recipient.

33. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource associated with a network identifier that is specific to said payment entity, the method comprising the steps of:
querying a directory based on the network identifier of the recipient to resolve a network address for the recipient, wherein the network address being associated with a public key for the recipient, wherein the directory is associated with the communication network; verifying that the network identifier of the recipient corresponds to a network identifier associated with the resolved network address for the recipient;
responsive to the verification being successful, performing the method step of any one of clauses 7 to 17 or clause 28 for a given transaction.

34. The method as set out in clause 33 wherein the network address is a cryptographically generated address and wherein the network identifier is a domain name for the recipient.

35. The method as set out in any one of clauses 33 or 34 wherein the network identifier is provided in an extension field associated with the network address.

36. A computing device, comprising:

a processor; and

memory including executable instructions that, as a result of execution by the processor, causes the system to perform the computer-implemented method of one of clauses 1 to 18, 28, 30, 31 to 33 to 35.

37. A computing device, comprising:

a processor; and

memory including executable instructions that, as a result of execution by the processor, causes the system to perform the computer-implemented method of one of clauses 19 to 27 or 29 to 32.

38. A system, comprising:

one or more sender entities, each sender entity being a computing device according to clause 36;

one or more recipient entities, each recipient entity being a computing device according to clause 37; and

a communication network for facilitating communication between at least one sender entity and at least one recipient entity.

39. A non-transitory computer-readable storage medium having stored thereon executable instructions that, as a result of being executed by a processor of a computer system, cause the computer system to perform the computer-implemented method of any one of clauses 1 to 35.

It should be noted that the above-mentioned embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

### Example Use Cases and Scenarios Based on the Above Aspects and Embodiments

Webserver Access

The functionality discussed in the above aspects can be easily leveraged using webservers today. Webservers can easily integrate IP Transaction functionality in order to charge clients for access. For example, a webserver could request a certain payment in order to reply to the client who is requesting certain access or functionality to a website or webserver. This payment could also be turned into a payment channel in order to allow for micropayments to be made.

Local Link Payments

A situation where IP transactions would be useful is when making a payment to someone or something relatively in a nearby vicinity, namely on the same local network link. To find IP addresses on the same subnet, the sender can broadcast a ping request on the subnet and get replies from active IP addresses. Also, with IPv6, Secure Neighbour Discovery (SEND) protocol could be used to discover other network nodes on the local link. The sender can then make a digital asset IP transaction using any one of the above discussed aspects relating to IPv6 to the receiver. One example where this could be used is if a user wanted to transfer a digital asset to someone physically close to them.

IP Messaging

The data item M discussed above may be used for any type of messaging, such as email. The procedure is related to the earlier discussion in relation to the second aspect, with the only difference that in the OP_RETURN output, the data item M is replaced by the encryption of M using the recipient's public key, as shown in the figure below. This need not constrained to just IP transactions and can be extended to any situation where the sender has a public key belonging to the receiver and wants to send them a private non-interactive message.

The message can be encrypted using the same method explained in relation to the second or third aspect, for instance. The message can also be encrypted using Pretty Good Privacy (PGP)/Gnu Privacy Guard (GPG) which uses a hybrid of asymmetric and symmetric encryption. This could be relevant since some email users already use PGP/GPG to encrypt and sign emails.

1. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource associated with a network identifier that is specific to said payment entity, the method comprising the steps of:
obtaining a public key P1 for the recipient;
verifying that the obtained public key P1 is associated with the network identifier of the recipient;
responsive to the verification being successful, calculating a further public key P2 pertaining to a given transaction based on the obtained public key, the given transaction associated with a digital asset;
computing a payment destination address for the recipient based on the further public (P2) key;
generating an output script for the given transaction based on the payment destination; and
providing an unspent transaction output (UTXO) based on the output script to the distributed ledger.

2. The method as claimed in claim 1 wherein the output script includes a reference to the network identifier of the recipient; and optionally wherein the network identifier is a domain name of the recipient, said domain name being known to the sender, or being obtained from a network address of the recipient that is known to the sender.

3. (canceled)

4. The method as claimed in claim 1 wherein the obtained public key P1 is part of a cryptographic key pair that includes a private key V1, such that one or more records associated with network identifier are encrypted with the private key V1; and optionally wherein the obtained public key P1 is digitally signed by a trusted authority (CA) to associate the obtained public key P1 to the network identifier of the recipient, and wherein the step of verifying the obtained public key P1 is performed based on another public key associated with the trusted authority.

5. (canceled)

6. The method as claimed in claim 1 wherein the network identifier is a network address associated with the recipient, and wherein the obtained public key P1 is based on key exchange information associated with the network address; and optionally wherein the step of verifying the obtained public key P1 is performed based on a certificate issued by a trusted authority (CA) for the network address.

7. (canceled)

8. The method as claimed in claim 1 comprising:
accessing a directory relating to a plurality of network identifiers;
identifying a record associated with the network identifier of the recipient; and
verifying an authenticity of the network identifier based on a security indicator present in the record.

9. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:
determining a network address for the recipient, said network address being associated with a public key P1 for the recipient;
verifying that the network address is generated for, and is specific to the recipient;
responsive to the verification being successful, calculating a further public key P2 pertaining to a given transaction based on the public key for the recipient, the given transaction associated with a digital asset;
computing a payment destination address for the recipient based on the further public P2 key;
generating an output script for the given transaction based on the payment destination; and
providing an unspent transaction output (UTXO) based on the output script to the distributed ledger.

10. The method as claimed in claim 9 wherein the output script includes a reference to a network identifier of the recipient; and optionally wherein the network address for the recipient is a cryptographically generated address (CGA) derived from a cryptographic key pair including the public key P1, and a corresponding private key V1 associated with the recipient.

11. (canceled)

12. The method as claimed in claim 9 wherein the step of verifying the network address is based on a digital signature provided by a trusted authority (CA) for establishing a secure communication channel with the recipient; and/or wherein the step of verifying the network address is based on a digital signature of the private key V2 that is included in a hash function used to generate the CGA for the recipient.

13. (canceled)

14. The method as claimed in claim 9 wherein the step of calculating a further public key P2 comprises:
applying a secure hash function to a data item associated with the given transaction M to obtain a result, the data item M relating to the digital asset to be provided to the recipient; and
associating the public key P1 for the recipient with the result.

15. The method as claimed in claim 1 wherein the step of computing the payment destination address includes computing a pay to public key hash (P2PKH) value based on applying a double hash function of the further public key P2, or wherein the step of computing a payment destination is based on a custom script associated with a public template for the recipient for digital assets transactions.

16. The method as claimed in claim 9 wherein the step of providing the UTXO to the distributed ledger includes providing an additional non-spendable output having a locking script including the network identifier or network address of the recipient for the given transaction.

17. The method as claimed in claim 9 comprising:
calculating a session key K1, wherein the session key is based on the further public key P2 for the given transaction, a private key V2 associated with the further public key and the public key P1 associated with the recipient;
encrypting a data item M of the given transaction with the session key K1, the data item M relating to the digital asset;
wherein the output script is generated based on the encrypted data item M.

18. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method comprising the steps of:
obtaining a public key P1 for the recipient;
calculating a first public key P21 pertaining to a first transaction TX1 based on the obtained public key, the first transaction TX1 associated with a digital asset;
computing a first payment destination address for the recipient based on the first public P21 key;
calculating a first session key K1, wherein the first session key is based on the first public key P21 for the first transaction, a first private key V21 associated with the first public key P21 and the public key P1 associated with the recipient;
encrypting a data item M associated with the first transaction TX1 with the first session key K1, the data item M relating to the digital asset;
generating a first output script for the first transaction TX2 based on the encrypted data item M and the first payment destination address;
providing an unspent transaction output (UTXO) based on the output script to the distributed ledger;
calculating a second public key P22 pertaining to a second transaction TX2 based on the obtained public key P1, the second transaction associated with the UTXO of the first transaction;
computing a second payment destination address for the recipient based on the second public P22 key;
calculating a second session key K2, wherein the second session key K2 is based on the second public key P22 for the second transaction TX2, a second private key V22 associated with the second public key P22 and the public key P1 associated with the recipient;
encrypting the data item M associated with the first transaction TX1 with the second session key K2;
generating a second output script based on the encrypted data item M and the second payment destination; and
providing the second output script to the distributed ledger, wherein the second output is a non-spendable output.

19. A computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing device associated with a network identifier that is specific to said payment entity, the method comprising the steps of:
providing a public key P1 associated with the recipient, the public key further associated with a certificate issued by a trusted authority;
querying or monitoring the distributed ledger for one or more unspent transaction outputs (UTXO) associated with the recipient;
responsive to detecting a UTXO associated with the recipient, whereby the detected UTXO pertains to a given transaction, calculating a private key V2 for the given transaction, the private key V2 associated with a public key P2 for the given transaction;
processing a digital asset or processing a transfer of the digital asset by executing one or more output scripts in the detected UTXO to complete the given transaction; and
storing the completed transaction in the distributed ledger.

20. The computer implemented method as claimed in claim 19 wherein the step of querying or monitoring the distributed ledger includes querying or monitoring for one or more UTXOs associated with the network identifier and/or a payment destination address of the recipient; and optionally wherein the step of querying or monitoring the distributed ledger comprises monitoring the distributed ledger for one or more non-spendable outputs associated with the recipient, the additional outputs related to the detected UTXO.

21. The computer implemented method as claimed in any-one claim 19, wherein the step of calculating the private key for the detected UTXO comprises:
obtaining a private key V1 associated with the recipient, the private key being part of a cryptographic key pair associated with the public key P1 of the recipient;
computing the private key V2 for the given transaction based on the private key V1 of the recipient and a hash of a data item M associated with the given transaction, the data item M relating to the digital asset.

22. (canceled)

23. The method as claimed in claim 19 wherein the one of more UTXOs are provided to the distributed ledger by the sender according to a method for implementing at least one transaction associated with the distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource, the method including the steps of:
determining a network address for the recipient, said network address being associated with a public key P1 for the recipient;
verifying that the network address is generated for, and is specific to the recipient;
responsive to the verification being successful, calculating a further public key P2 pertaining to a given transaction based on the public key for the recipient, the given transaction associated with a digital asset;
computing a payment destination address for the recipient based on the further public P2 key;
generating an output script for the given transaction based on the payment destination; and
providing an unspent transaction output (UTXO) based on the output script to the distributed ledger.

24. The method as claimed in claim 19 comprising:
calculating a session key K1, wherein the session key is based on the public key and private key P2, V2 associated with the given transaction, and the public key P1 associated with the recipient;
wherein the step of executing one or more output scripts includes decrypting a data item M associated with the given transaction in the one or more output scripts using the session key K1, the data item M relating to the digital asset.

25-39. (canceled)

40. A non-transitory computer-readable storage medium having stored thereon executable instructions that, as a result of being executed by a processor of a computer system, cause the computer system to perform a computer implemented method for implementing at least one transaction associated with a distributed ledger, the at least one transaction being from sender for a recipient, whereby the sender and recipient are each associated with a respective payment entity among a plurality of payment entities that are communicatively coupled via a communication network, whereby each payment entity among the plurality of payment entities is a computing resource associated with a network identifier that is specific to said payment entity, the method comprising the steps of:
obtaining a public key P1 for the recipient;
verifying that the obtained public key P1 is associated with the network identifier of the recipient;
responsive to the verification being successful, calculating a further public key P2 pertaining to a given transaction based on the obtained public key, the given transaction associated with a digital asset;
computing a payment destination address for the recipient based on the further public (P2) key;
generating an output script for the given transaction based on the payment destination; and
providing an unspent transaction output (UTXO) based on the output script to the distributed ledger.
